(19) United States
(12) Patent Application Publication
(10) Pub. No.: US 2024/0117138 A1
(43) Pub. Date: Apr. 11, 2024

(54) FOAMED COMPOSITIONS, FOAM PADDED MATERIALS, AND PACKAGING ARTICLES

(71) Applicant: 3M INNOVATIVE PROPERTIES COMPANY, St. Paul, MN (US)

(72) Inventors: Yaohua Gao, Woodbury, MN (US); Stephen M. Sanocki, Stillwater, MN (US); Sithya S. Khieu, Eden Prairie, MN (US); Ignatius A. Kadoma, Cottage Grove, MN (US); Cory D. Sauer, Star Prairie, WI (US); Tien Yi T.H. Whiting, St. Paul, MN (US); Mitchell A.F. Johnson, Woodbury, MN (US); Jeffrey P. Kalish, Woodbury, MN (US); Daniel L. Schlosser, Roseville, MN (US); Michael Brett Runge, Stillwater, MN (US); Matt R. Branscomb, Lakeville, MN (US)

(21) Appl. No.: 18/274,690

(22) PCT Filed: Feb. 1, 2022
(86) PCT No.: PCT/US2022/014672

§ 371 Date: Jul. 27, 2023

Related U.S. Application Data
(63) Continuation-in-part of application No. PCT/US2022/014499, filed on Jan. 31, 2022.
(60) Provisional application No. 63/214,648, filed on Jun. 24, 2021.
(60) Provisional application No. 63/160,168, filed on Mar. 12, 2021.
(60) Provisional application No. 63/148,117, filed on Feb. 10, 2021.
(60) Provisional application No. 63/144,360, filed on Feb. 1, 2021.

(51) Int. Cl. C08J 9/32; C08J 7/04; D21H 19/70

(52) U.S. Cl. CPC C08J 9/32; C08J 7/0427; D21H 19/70; C08J 2203/22; C08J 2329/14

(57) ABSTRACT

Disclosed are polymeric foamed compositions, foam padded materials that include such polymeric foamed compositions disposed on a sheet material, and packaging articles (e.g., envelopes) made from such foam padded materials. The polymeric foamed composition on the sheet material has a plurality of foamed structures formed from the foamable composition attached to the sheet material by a layer of the foamable composition, and the plurality foam structures each having a hollow core and a foam exterior shell.

### BACKGROUND

Existing packaging (e.g., shipping envelopes) come in two general forms—with and without a cushioning layer. Cushioning is a key element of protective packaging. The use of closed cell extruded polystyrene foam or bubble wrapping, such as that available under the trade designation “BUBBLE WRAP”, as a cushioning component in packaging is known. Such materials may not be recyclable or compostable. Thus, most end up as landfill waste. Even if they are recyclable, it is established that plastic products are recycled at a much lower rate than paper-based products. More environmentally friendly approaches to making packaging have been attempted based on cellulosic materials and water-based adhesives; however, such packaging materials may not be sufficiently durable to provide suitable properties (e.g., effective thermal insulation, impact protection, and compression resistance).

### SUMMARY

The present disclosure provides polymeric foamed compositions, foam padded materials that include such polymeric foamed compositions, and packaging articles (e.g., envelopes) that include such foam padded materials.

In one embodiment, there is provided a foamed composition that includes: a polymeric component on sheet materials where the polymeric component forms foam structures with a hollow interior and a foamed porous outer shell. These materials may be recyclable and/or compostable when using appropriate material sections for the sheet material and foamed composition. These foamed sheet materials can have mechanical structures quite similar to “BUBBLE WRAP” and have the advantage of being easier to recycle and/or compostable.

In another embodiment, there is provided a recyclable and/or compostable foam padded material that includes: a sheet material having a first and a second major surface, wherein the sheet material includes a recyclable material (e.g., paper); and a polymeric component forming a plurality of foamed structures each with a hollow interior and with a foamed porous outer shell disposed on the first major surface of the sheet material, the foamed composition is as described herein.

In another embodiment, there is provided an optional recyclable and/or compostable foam padded material that includes: a sheet material having a first and a second major surface, and a foamed composition is disposed on the first major surface and on the second major surface of the sheet material, the foamed composition forming a plurality of foamed structures each having a hollow interior and with a foamed porous outer shell.

In yet another embodiment, there is provided a packaging article that includes: a first wall having a first interior surface and a first exterior surface opposite the first interior surface; a second wall having a second interior surface and a second exterior surface opposite the second interior surface, the first and second interior surfaces defining an interior of the packaging article and the first and second exterior surfaces defining an exterior of the packaging article; a foamed composition disposed on at least a portion of each of the first and second interior surfaces; and a sealing joint at one or more edges of the first and second walls, the sealing joint including the foamed composition, which attaches the first wall to the second wall; wherein the first and second walls can include a recyclable material and the foamed composition is as described herein.

In yet another embodiment, there is provided a packaging article that includes: a first wall having a first interior surface and a first exterior surface opposite the first interior surface; a second wall having a second interior surface and a second exterior surface opposite the second interior surface, the first and second interior surfaces defining an interior of the packaging article and the first and second exterior surfaces defining an exterior of the packaging article; the first wall and the second wall each comprising a first and a second sheet material opposing each other and a foamed composition as described herein is disposed between the first sheet material and the second sheet material in the packaging article.

In yet another embodiment, there is provided a packaging article that includes: a first wall having a first interior surface and a first exterior surface opposite the first interior surface; a second wall having a second interior surface and a second exterior surface opposite the second interior surface, the first and second interior surfaces defining an interior of the packaging article and the first and second exterior surfaces defining an exterior of the packaging article; a foamed composition disposed on at least a portion of each of the first and second interior surfaces; and a sealing joint at one or more edges of the first and second walls, the sealing joint including the foamed composition, which attaches the first wall to the second wall; wherein the first and second walls include recyclable material and the foamed composition is as described herein.

In yet another embodiment, there is a sheet material having a first side and an opposing second side; a foamed composition as described here in disposed on the both the first side and the second side. In some embodiments, the foamed composition comprises a plurality of foamed structures each having a hollow interior and with a foamed porous outer shell.

In yet another embodiment, the packing article contains a foamed composition disposed on at least a portion of each of the first and second interior surface in discrete patterns with area containing no foamed composition, covering 20%, 30%, 40%, 50%, 60%, 80%, 90%, and 95% of the interior surface. For example, there may be no foam in the flap and/or folded area of the construction.

In yet another embodiment there is a packaging material having a first sheet material; a plurality of foam structures formed from a foamable composition attached to the sheet material by a layer of the foamable composition, the plurality of foam structures each having a hollow core and a foam exterior shell, and wherein a total porosity of the plurality of foam structures is determined by X-ray microtomography by adding a hollow core volume to an exterior shell void volume and then dividing the sum by a foam structure volume and multiplying by 100, and the total porosity is greater than 50% and less than 100%. This embodiment is made by rotogravure printing the foamable composition onto the sheet material attaching the foamable composition to the sheet material by a layer of the foamable composition and then drying the foamable composition to foam into into the the foam structures having a hollow core and a foam exterior shell as best seen in FIGS. 18 and 19.

Some terms in this disclosure are defined below. Other terms will be familiar to the person of skill in the art and should be afforded the meaning that a person of ordinary skill in the art would have ascribed to them.

The terms “polymer” and “polymeric material” include, but are not limited to, organic homopolymers, copolymers, such as for example, block, graft, random, and copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “copolymer” refers to polymers containing two or more different monomeric units or segments, including terpolymers, tetrapolymers, etc.

The term “compostable” refers to materials, compositions, or articles that meet the standard ASTM D6400 or ASTM D6868. It should be noted that those two standards are applicable to different types of materials, so the material, composition, or article need only meet one of them, usually whichever is most applicable, to be “compostable” as defined herein. In certain embodiments, the term “compostable” preferably refers to materials, compositions, or articles that meet the standard ASTM D6400. Particularly, compostable materials, compositions, or articles will also meet the ASTMD5338 standard. Particularly, compostable materials, compositions, or articles will also meet one or more of the EN 13432, AS 4736, AS 5810, or ISO 17088 standards. More particularly, compostable materials, compositions, or articles will also meet the ISO 14855 standard. It should be noted that the term “compostable” as used herein is not interchangeable with the term “biodegradable.” Something that is “compostable” must degrade within the time specified by the above standard or standards into materials having a toxicity, particularly plant toxicity, that conform with the above standard or standards. The term “biodegradable” does not specify the time in which a material must degrade nor does it specify that the compounds into which it degrades pass any standard for toxicity or lack of harm to the environment. For example, materials that meet the ASTM D6400 standard must pass the test specified in ISO 17088, which addresses “the presence of high levels of regulated metals and other harmful components,” whereas a material that is “biodegradable” may have any level of harmful components.

The term “recyclable” refers to materials, compositions, or articles that meet at least one of the Voluntary Standard for Repulping and Recycling Corrugated Fiberboard as promulgated by the Fibre Box Association (FBA) part 1 (repulpability), Voluntary Standard for Repulping and Recycling Corrugated Fiberboard as promulgated by the Fibre Box Association (FBA) part 2 (recyclability), and ISO 18601 standards. Particular recyclable items meet the Voluntary Standard for Repulping and Recycling Corrugated Fiberboard part 1 (repulpability). Particular recyclable items meet the Voluntary Standard for Repulping and Recycling Corrugated Fiberboard part 2 (recyclability). More particular recyclable items meet the Voluntary Standard for Repulping and Recycling Corrugated Fiberboard part 1 (repulpability) and part 2 (recyclability). Still more particularly, recyclable items meet the Voluntary Standard for Repulping and Recycling Corrugated Fiberboard part 1 (repulpability) and part 2 (recyclability) standards, as well as the ISO 18601 standard. Even more particularly, recyclable items additionally meet the ISO 18604:2013 standard.

All references to the Voluntary Standard for Repulping and Recycling Corrugated Fiberboard standard, whether to part 1, part 2, or both, refer to the 2013 version of the standard. It should be noted that a recyclable material may include materials, such as adhesives, that do not meet one or more of the above standards. This is because materials, particularly adhesives, are commonly removed from paper products during the recycling process. Such materials, especially adhesives, that are not themselves recyclable but are readily removed from a product during the recycling process are referred to herein as “recycle-compatible.” A “recyclable” article thus may contain components that are recyclable as well as components that are recycle-compatible.

Throughout this disclosure, singular forms such as “a,” “an,” and “the” are often used for convenience; however, the singular forms are meant to include the plural unless the singular alone is explicitly specified or is clearly indicated by the context. When the singular alone is called for, the term “one and only one” is typically used.

The term biodegradable refers to materials that degrade by aerobic biodegradation in the presence of soil microorganism as defined by ASTM D5988-18, or by aerobic biodegradation under controlled composting conditions as defined by ASTM 5338-15, or by anaerobic biodegradation under high solids anaerobic-digestion conditions such as in treatment centers for municipal solid waste, biologically active landfills as defined by ASTM D5511-18.

Terms indicating a high frequency, such as (but not limited to) “common,” “typical,” and “usual,” as well as “commonly,” “typically,” and “usually” are used herein to refer to features that are often employed in the disclosure and, unless specifically used with reference to the prior art, are not intended to mean that the features are present in the prior art, much less that those features are common, usual, or typical in the prior art.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.). Also, when a several of lower limits of a variable are recited sequentially and several upper limits of the same variable are recited sequentially, ranges of that variable between any selected lower limit and any selected upper limit are within the scope of the disclosure.

The term “in the range” or “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIGS. 1A-1G are photographs of exemplary foam padded materials;

FIG. 2 is a schematic of an exemplary packaging article;

FIG. 3 is a schematic of another exemplary packaging article;

FIG. 4 is a schematic of yet another exemplary packaging article;

FIGS. 5 and 6 are schematics of still another exemplary packaging article with a flap in the open (5) and closed (6) configurations;

FIG. 7A is a schematic of another exemplary packaging article with an adhesive portion;

FIG. 7B is a schematic of yet another exemplary packaging article with two adhesive portions on a flap;

FIGS. 8A and 8B are photographs of an exemplary packaging article;

FIG. 9 is a schematic of an unwind station, rotogravure station, oven, and winder;

FIGS. 10A-10C are schematics of exemplary packaging articles;

FIG. 11 is a 3D printed rotogravure printing roll with a pattern on the surface;

FIGS. 12A and 12B are schematics of another packaging article;

FIG. 13 is a schematic of a 3D printed rotogravure roll;

FIG. 14 is a drawing showing a rotogravure cell dimension for dl which the diameter of an inscribed circle tangent to the sides of a hexagon drawn by connecting the centers of the individual cells in the rotogravure array;

FIG. 15 is a plan view of an embodiment of the invention with a foamed composition forming a plurality of foam bubbles in a patterned array attached to a substrate;

FIG. 16 is a cross-section of the embodiment of FIG. 15 showing each foam bubble comprises an exterior shell of a foamed composition and a hollow interior filled with air;

FIG. 17 is a schematic of a mailer made from the embodiment of FIG. 16 with heat sealed seams where the foam bubbles were compressed and heat sealed together to form a pouch with an interior having a cushioning array of foam bubbles.

FIG. 18 is optical micrograph of a cross section of the foamed bubbles on a substrate each foamed bubble has an exterior shell of a foamed composition and a hollow interior filled with air.

FIG. 19 is an image using x-ray tomography showing the porous outer shell of the foamed bubbles and the inner hollow core of the foamed bubble on a substrate.

FIG. 20 show the exterior of rotogravure printing rolls for applying the foamed composition to a substrate in rectangular patterns having a diagonal orientation.

FIG. 21 shows a patterned sheet with coated and uncoated areas on a substrate.

### DETAILED DESCRIPTION

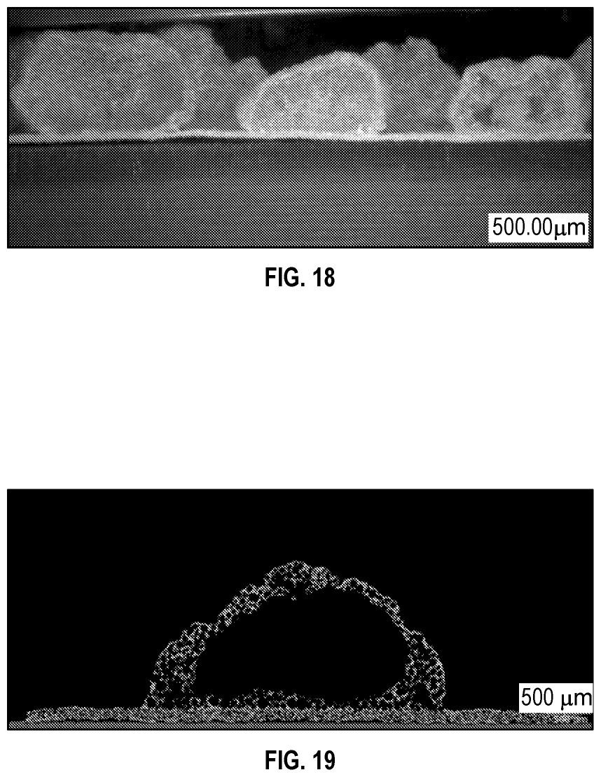

The present disclosure provides polymeric foamed compositions. The foamed composition includes: a polymeric component that forms a plurality of foam structures on a sheet material. The foamed structures may have a hollow interior and a foamed exterior shell as best seen in FIGS. 18 and 19.

Such polymeric foamed compositions can be used in recyclable and/or compostable foam, and/or biodegradable padded materials and packaging articles (e.g., envelopes). The foam padded material includes: a sheet material 10 having a first major surface 12 and a second major surface 14 opposing the first major surface, wherein the sheet material optionally includes recyclable material; and a foamed composition 16, as described herein, disposed on the first major surface and/or the second major surface of the sheet material.

Briefly, a packaging article includes a first wall having a first interior surface and a first exterior surface opposite the first interior surface as well as a second wall having a second interior surface and a second exterior surface opposite the second interior surface. The first and second interior surfaces define an interior of the packaging article and the first and second exterior surfaces define an exterior of the packaging article. The packaging article has one or more edges where the first wall is attached to the second wall at a sealing joint. Optionally, the article may have at least one opening where the first wall is not attached to the second wall; this is not required in all cases because it is possible to form the packaging article around an object to be placed in the interior of the packaging article thereby eliminating the need for an article with an opening. A foamed composition, as described herein, is disposed on at least a portion of each of the first and second interior surfaces. Preferably, the foamed composition also forms the sealing joint, thereby attaching the first wall to the second wall of the packaging article.

In certain embodiments, the polymeric foamed compositions, foam padded materials, or packaging articles are recyclable. In certain embodiments, the polymeric foamed compositions, foam padded materials, or packaging articles are compostable. In certain embodiments, the polymeric foamed compositions, foam padded materials, or packaging articles are biodegradable. In certain embodiments, the polymeric foamed compositions, foam padded materials, or packaging articles are both recyclable and/or compostable and/or biodegradable.

### Foamed Composition

The foamed composition is an organic polymeric foam, i.e., a composite of a polymer matrix (i.e., polymeric component) and a gas dispersed therein, typically in bubbles or cells. During foam volumetric expansion, a gas phase is initially dispersed into a continuous polymeric phase. A polymeric foam can be prepared mechanically (e.g., by air dispersion, frothing), physically (e.g., by gas injection, bead foaming, expandable microspheres), or chemically (e.g., by using a foaming agent that generates effective gases through thermal decomposition, or solvent vaporization).

Such foamed compositions typically include closed cell foams although open cell foams are also possible. In certain embodiments, the foams include closed cells, optionally with open cells and/or ruptured cells.

The foamed compositions of the present disclosure can be water soluble, and preferably at least partially water soluble. In the context of the foam (i.e., foamed composition), an at least partially water-soluble foam means at least 50% of the foam dissolves in 130° F. (54° C.) water according to the Water Solubility Test described in the Examples Section. In certain embodiments, at least 60%, at least 70%, at least 80%, at least 85%, at least 90%, at least 95% of the foam (i.e., foamed composition) dissolves in 130° F. (54° C.) water according to the Water Solubility Test described in the Examples Section. Such foamed compositions include water-soluble components such as one or more polymers, and one or more optional water-soluble additives at room or elevated temperatures, as described in greater detail below.

The foamed compositions (i.e., foams) of the present disclosure are preferably heat-sealable. By this it is meant that a foamed composition is sufficiently thermoplastic; that it liquifies and flows upon being exposed to thermal energy, mechanical energy, or a combination thereof (e.g., heat sealing, sonic welding) and re-solidifies upon cooling, thereby providing a seal between two substrate materials having the foamed composition disposed therebetween. The sealability of the foamed compositions can be quantified using the Seam Strength Test described in the Examples section. In certain embodiments, the foamed compositions of the present disclosure have a seam strength of at least 1.0 lbs/in, at least 2.0 lbs/in, or at least 4.5 lbs/in.

In certain embodiments, foam compositions are biodegradable. By this it is meant that greater than at least 50%, at least 60%, at least 70%, at least 80%, at least 90%, at least 95% internal integrity of the foam, adhesion of the foam to a substrate, as demonstrated by foam shedding or adhesion to paper, the ability of foam to absorb impact, and the ability of the foam to resist compression. The durability of the foamed compositions can be quantified by the Abrasion Resistance test method in the Examples.

In certain embodiments, the foamed compositions of the present disclosure have a shedding mass loss of foam from Taber abrasion testing as described herein of no greater than 50%, no greater than 40%, no greater than 30%, no greater than 20%, or no greater than 10%, after abrasion according to the Abrasion Resistance Test described herein.

In certain embodiments, the polymeric component (i.e., polymer matrix) of the foamed composition, which may include one or more polymers, is present in an amount of at least 60 wt-%, at least 65 wt-%, at least 70 wt-%, at least 75 wt-%, at least 80 wt-%, at least 85 wt-%, or at least 90 wt-%, based on the total weight of the foamed composition (i.e., the final (dried) foam, which may include residual water). In certain embodiments, the polymeric component of the foamed composition, which may include one or more polymers, is present in an amount of up to 99.5 wt-%, based on the total weight of the (final) foamed composition. The remainder of the foamed composition includes a gas (e.g., air) dispersed therein, and may also include one or more foaming agents (e.g., expandable microspheres), residue of such foaming agents after the composition has been foamed (e.g., expanded microspheres), fillers, and other optional additives, as described in greater detail below. In certain preferred embodiments, the remainder of the foamed composition includes a gas and expanded microspheres (i.e., the foaming agent residue resulting after the composition is foamed and the expandable microspheres have expanded), as discussed below.

The polymeric component of the foamed composition is formed using a solution of polymer, or mixture of polymers, in a solvent. The polymer may be soluble in the solvent, the polymer may be an emulsion, or may be a polymer dispersion. The solvent can be water or any organic solvent including, but not limited to: isopropyl alcohol, ethanol, methanol, methyl ethyl ketone, ethyl acetate, hexane, heptane, methyl acetate, acetone, xylene, toluene, benzene, or blends of solvents.

The polymeric component of the foamed composition can be formed using a water-based polymer or mixture of polymers that are typically selected to be foamable, at least partially water soluble, and preferably provide one or more of the following properties to a foam padded material or packaging article: impact protection; cushioning; thermal insulation; compression resistance; water resistance; recyclability; biodegradability; and/or composability.

For foamability, such polymers are generally highly plasticized by water or solvent. This allows efficient foaming, particularly when the foaming is provided by expansion of expandable microspheres upon heating. The water-based polymers are typically prepared by emulsion polymerization using a single grade or a mixture of emulsion polymers, which may be of synthetic or natural origin.

In certain embodiments, the polymeric component is a polymer selected from the group including butanediol vinyl alcohol polymer or copolymer, starch, vinyl acetate/ethylene copolymer, polyvinyl acetate, polyvinyl alcohol, dextrin stabilized polyvinyl acetate, vinyl alcohol/vinyl acetate copolymer, vinyl alcohol/vinyl acetate/ethylene copolymer, stabilized polyvinyl acrylate copolymer, vinyl (methyl)acrylic, styrene (meth)acrylic, (meth)acrylic, styrene butyl rubber, natural rubber, styrenic block copolymer, polyurethane, polyethylene, polyethyleneoxide, polyethylene glycol, polyacrylic acid, polymethacrylic acid, polyvinyl pyrrolidone, polyacrylamide, polypropylene glycol, polypropylene oxide,—polylactic acid, polyglycolic acid, polycaprolactone, polybutylene succinate, polybutylene adipate terephthalate, cellulose, and mixtures or copolymers thereof.

One such commercially available polymer is that available under the trade designation “DUR—O-SET” (Celanese, Florence, KY USA), a polyvinyl alcohol stabilized vinyl acetate ethylene (VAE) emulsion. In certain embodiments, the polymer can be neutral or contain charged monomers (anionic, cationic, zwitterionic). One such commercially available polyvinyl alcohol polymer is that available under the trade designation “POVAL” and “MOWIFLEX” (Kuraray, Houston, TX, USA), a polyvinyl alcohol polymer.

Suitable polymers for making the foamed composition are typically obtained from a supplier in pellet or powder form and dissolved or dispersed in water or solvent. Or they may be obtained as a dispersion or emulsion. Typically, such dispersions or emulsions have a solids content of 10 wt-% to 70 wt-%. Thus, a foamed composition of the present disclosure (i.e., a final foam) is prepared from a solvent-containing formulation, referred to herein as a “foamable” composition.

In certain embodiments the solvent is water. In other embodiments, the solvent is an organic solvent, and the polymer is soluble or dispersable or able to form an emulsion in the organic solvent.

Suitable polymers include but are not limited to: polyesters, polyethers, polyolefins, polyamides, polyacrylates, polymethacrylates, polymethylmethacrylates, silicone or siloxane polymers, polyurethanes, polylactones, polylactams, polysulfides, polypeptides, polysaccharides, styrenic polymers, a blend of polymers, or copolymers.

Preferably, one or more polymers are water-soluble polymers. In the context of the polymer, water soluble means at least 90 wt-% of the polymer dissolves in 130° F. (54° C.) water, in a procedure analogous to the Water Solubility Test described in the Examples Section. In certain embodiments, at least 95 wt-%, or at least 99 wt-%, of a water-soluble polymer dissolves in 130° F. (54° C.) water, in a procedure analogous to the Water Solubility Test described in the Examples Section.

In certain embodiments, the polymeric component includes a copolymer, preferably, a water-soluble copolymer, that includes divalent hydroxyethylene monomer units (i.e., —CH₂—CH(OH)—) and divalent dihydroxybutylene monomer units (referred to herein as a “hydroxy-ethylene-butylene copolymer”). In certain embodiments, the polymeric component may include one or more of such hydroxy-ethylene-butylene copolymers (e.g., varying by monomer composition, molecular weight, melt flow index). In preferred embodiments, the divalent dihydroxybutylene monomer units comprise 3,4-dihydroxybutan-1,2-diyl monomer units (i.e., monomer units of the structure

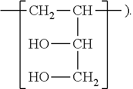

Optionally, but typically, the copolymer further includes acetoxyethylene divalent monomeric units (i.e., monomer units of the structure

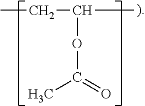

The copolymer may be obtained by copolymerization of vinyl acetate and 3,4-dihydroxy-1-butene followed by partial or complete saponification of the acetoxy groups to form hydroxyl groups. Alternatively, in place of 3,4-dihydroxy-1-butene, a carbonate such as:

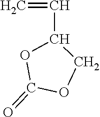

can also be used. After copolymerization, this carbonate may be hydrolyzed simultaneously with saponification of the acetate groups. In another embodiment, in place of 3,4-dihydroxy-1-butene, an acetal or ketal having the formula:

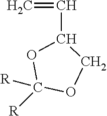

can be used, where each R is independently hydrogen or alkyl (e.g., methyl or ethyl). After copolymerization, this carbonate may be hydrolyzed simultaneously with saponification of the acetate groups, or separately. The copolymer can be made according to known methods or obtained from a commercial supplier, for example.

Commercially available water-soluble copolymers may include those available under the trade designation “NICHIGO G-POLYMER” (Nippon Gohsei Synthetic Chemical Industry, Osaka, Japan), a highly amorphous polyvinyl alcohol, that is believed to have divalent monomer units of hydroxyethylene, 3,4-dihydroxybutan-1,2-diyl, and optionally acetoxyethylene. Nippon Gohsei also refers to “NICHIGO G-POLYMER” by the chemical name butenediol vinyl alcohol (BVOH). Exemplary materials include “NICHIGO G-POLYMER” grades AZF8035W, OKS-1024, OKS-8041, OKS-8089, OKS-8118, OKS-6026, OKS-1011, OKS-8049, OKS-8074P, OKS-1028, OKS-1027, OKS-1109, OKS-1081, and OKS-1083. An exemplary “G-POLYMER” is available under the trade designation “OKS-8074P” from Soarus LLC, Arlington Heights, IL, USA. These hydroxy-ethylene-butylene copolymers are believed to have a saponification degree of 80 to 97.9 mole percent, and further contain an alkylene oxide adduct of a polyvalent alcohol containing 5 to 9 moles of an alkylene oxide per mole of the polyvalent alcohol.

A hydroxy-ethylene-butylene copolymer is selected to provide foamability, at least partial water-solubility, and preferably durability and/or heat-sealability, to the foamed composition. Physical properties of the hydroxy-ethylene-butylene copolymer that may contribute to such performance properties include melt flow index, molecular weight, melt temperature, and degradation temperature.

In certain embodiments, one or more of the hydroxy-ethylene-butylene copolymers in the polymeric component has a melt flow index of at least 0.1 gram (g) per 10 minutes (min), or at least 0.5 g per 10 min (measured at 210° C. with a load of 2.16 kg). In certain embodiments, one or more of the hydroxy-ethylene-butylene copolymers in the polymeric component has a melt flow index of up to 60 g per 10 min, up to 50 g per 10 min, up to 40 g per 10 min, up to 30 g per 10 min, up to 20 g per 10 min, or up to 10 g per 10 min (measured at 210° C. with a load of 2.16 kg).

In certain embodiments, one or more of the hydroxy-ethylene-butylene copolymers in the polymeric component has a melt temperature of at least 90° C., at least 140° C., or at least 155° C. (measured by differential scanning calorimetry (DSC)). In certain embodiments, one or more of the hydroxy-ethylene-butylene copolymers in the polymeric component has a melt temperature of up to 220° C., up to 200° C., or up to 195° C. (measured by DSC).

These hydroxy-ethylene-butylene copolymers may be used alone as the polymeric component of the foam or may be used in combination with other (secondary) organic polymers. These secondary polymers may or may not be water soluble.

In certain embodiments, one or more hydroxy-ethylene-butylene copolymers are present in the polymeric component in an amount of at least 1 wt-%, at least 10 wt-%, at least 15 wt-%, at least 25 wt-%, at least 50 wt-%, at least 60 wt-%, or at least 70 wt-% based on the total weight of the polymeric component of the (final) foamed composition. In certain embodiments, one or more hydroxy-ethylene-butylene copolymers are present in the polymeric component in an amount of up to 100 wt-%, up to 90 wt-%, or up to 80 wt-%, based on the total weight of the polymeric component of the (final) foamed composition. These values also characterize the polymeric component, prior to foaming, if the water of the foamable composition is not included.

In certain embodiments, a foamed composition is formed from a foamable water-containing composition that includes at least 1 wt-%, at least 10 wt-%, at least 15 wt-%, at least 25 wt-%, at least 50 wt-%, at least 60 wt-%, or at least 70 wt-% of the hydroxy-ethylene-butylene copolymer, based on the total weight of the (final) foamed composition. In certain embodiments, a foamed composition is formed from a foamable water-containing composition that includes up to 99.5 wt-%, up to 95 wt-%, up to 90 wt-%, up to 80 wt-%, up to 70 wt-%, or up to 60 wt-%, of the hydroxy-ethylene-butylene copolymer, based on the total weight of the (final) foamed composition.

In certain embodiments, a foamed composition is formed from a foamable water-containing composition that includes at least 1 wt-%, at least 10 wt-%, at least 15 wt-%, at least 25 wt-%, at least 50 wt-%, at least 60 wt-%, or at least 70 wt-% of the hydroxy-ethylene-butylene copolymer, based on the total weight of the (final) foamed composition. In certain embodiments, a foamed composition is formed from a foamable water-containing composition that includes up to 99.5 wt-%, up to 95 wt-%, up to 90 wt-%, up to 80 wt-%, up to 70 wt-%, or up to 60 wt-%, of the hydroxy-ethylene-butylene copolymer, based on the total weight of the (final) foamed composition.

In certain embodiments, the polymeric component includes a polymer or copolymer, preferably, a water-soluble polymer or copolymer that includes polyvinyl alcohol units. Polyvinyl alcohol (PVOH) is a water-soluble polymer commercially obtained from Kuraray America (Houston, TX USA) under the “POVAL” trade designation or Sekisui Specialty Chemicals America, LLC (Dallas, TX USA) under the trade designation “SELVOL”. Polyvinyl alcohol is available in different molecular weights and degrees of hydrolysis. Polyvinyl alcohol is synthesized by hydrolysis of polyvinyl acetate. The degree of hydrolysis refers to the amount of acetate groups that have converted to alcohol groups. Suitable degrees of hydrolysis range from 60% to 99%, or from 70% to 95%, or from 80% to 90%. Molecular weight of PVOH is proportional to viscosity in water—for example a higher molecular weight PVOH will also have higher solution viscosity at the same concentration. Viscosity measured at 20 degrees Celsius in a 4% aqueous solution ranges from 2 to 50 mPa*s, or from 3 to 20 mPa*s, or from 4 to 10 mPa*s.

In certain embodiments, a foamed composition is formed from a foamable water-containing composition that includes at least 1 wt-%, at least 10 wt-%, at least 15 wt-%, at least 25 wt-%, at least 50 wt-%, at least 60 wt-%, or at least 70 wt-% of the PVOH polymer or copolymer based on the total weight of the (final) foamed composition. In certain embodiments, a foamed composition is formed from a foamable water-containing composition that includes up to 99.5 wt-%, up to 95 wt-20%, up to 90 wt-%, up to 80 wt-%, up to 70 wt-%, or up to 60 wt-%, of the PVOH polymer or copolymer, based on the total weight of the (final) foamed composition.

In certain embodiments, the polymeric component includes a polymer or copolymer, preferably, a water-soluble polymer or copolymer that includes acrylate units. Polyacrylate or polymethacrylate polymers and copolymers can be obtained by the polymerization of acrylic esters such as:

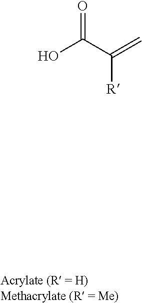

Polyacrylate (PA) polymers can be obtained as a solid, a liquid dispersion, or emulsion. Polyacrylate polymers can be obtained from BASF (Houston TX) under the trade designation JONCRYL. The variety and availability of acrylic ester monomers, polyacrylate polymers and polyacrylate copolymers is extensive. Some well-known examples include polyacrylates polymethyl acrylate, polymethyl methacrylate, polyethyl acrylate, poly butyl acrylate, polynorbornyl acrylate, polyacrylic acid, polyacrylamide, as well as polyacrylate polymers and copolymers and is extensive with varying degrees of water solubility dependent on ester groups denoted as R such as:

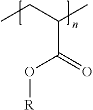

and/or degree of hydrolysis. In certain embodiments, a foamed composition is formed from a foamable water-containing composition that includes at least 1 wt-%, at least 10 wt-%, at least 15 wt-%, at least 25 wt-%, at least 50 wt-%, at least 60 wt-%, or at least 70 wt-% of the polyacrylate polymer or copolymer based on the total weight of the (final) foamed composition. In certain embodiments, a foamed composition is formed from a foamable water-containing composition that includes up to 99.5 wt-%, up to 95 wt-%, up to 90 wt-%, up to 80 wt-%, up to 70 wt-%, or up to 60 wt-%, of the polyacrylate polymer or copolymer, based on the total weight of the (final) foamed composition.

In certain embodiments the polymeric component includes a polymer or copolymer, preferably, a water-soluble polymer or copolymer that includes polyvinylpyrrolidone units. Polyvinylpyrrolidone (PVP) is a water-soluble polymer synthesized from N-vinylpyrrolidone monomer.

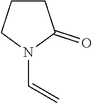

Polyvinylpyrrolidone is a hygroscopic, amorphous polymer supplied as a white, free-flowing powder or a clear aqueous solution. Available in several molecular weight grades, they are characterized by K-value, and used in a great variety of applications. Polyvinylpyrrolidone can be plasticized with water and most common organic plasticizers. Applications take advantage of one or more properties inherent in the polymer, typically due to the lactam ring. High polarity and the resultant propensity to form complexes with hydrogen donors, such as phenols and carboxylic acids, as well as anionic dyes and inorganic salts, are present. Components in a mixture are uniformly distributed through the use of polyvinylpyrrolidone, where this is known as dispersancy. The substantial water solubility of polyvinylpyrrolidone (hydrophilicity) is its dominant feature and frequently a factor along with other properties valuable to numerous applications. Adhesion is a result of the higher molecular weight polyvinylpyrrolidones formulated in aqueous media, with sufficient water that is then evaporated to generate a solid product for the desired application. PVP materials can be obtained from Ashland Chemicals under the K-series trade designated product line.

In certain embodiments, the polymeric component includes a vinyl acetate ethylene (VAE) copolymer. VAE copolymers are made from the copolymerization of ethylene and vinyl acetate monomers. VAE copolymers typically have a vinyl acetate concentration range of between 60-95 mol-% and the ethylene content can range between 5-40 mol-% and are supplied as water-based emulsions. VAE emulsion copolymers are sold under the trade designation “DUR—O-SET” by Celanese Corporation (Irving TX). By varying the ethylene content of the VAE copolymer, the glass transition temperature, Tg, can be tailored. VAE glass transition temperatures typically range from −15° C. to 30° C. In certain embodiments, a foamed composition is formed from a foamable water-containing composition that includes at least 1 wt-%, at least 10 wt-%, at least 15 wt-%, at least 25 wt-%, at least 50 wt-%, at least 60 wt-%, or at least 70 wt-% of the VAE copolymer. In certain embodiments, a foamed composition is formed from a foamable water-containing composition that includes up to 99.5 wt-%, up to 95 wt-%, up to 90 wt-%, up to 80 wt-%, up to 70 wt-%, or up to 60 wt-%, of the VAE copolymer, based on the total weight of the (final) foamed composition.

In certain embodiments the polymer or copolymers in the foamable composition have a Tg of at least −20° C., at least −15° C., at least 0° C., or at least 15° C. In certain embodiments the polymer or copolymers have a Tg up to 180° C., up to 75° C., up to 25° C. or up to 0° C. In certain embodiments there are blends of two or more polymers and/or copolymers where one polymer has a Tg of at least −20° C., and any addition polymers or copolymers have a Tg of up to 180° C. Ranges between these limits are within the disclosure such as −20° C. to 180° C.

If used, one or more secondary polymers is present in the polymeric component in an amount of up to 99%, up to 90%, up to 80%, up to 75 wt-%, up to 60 wt-%, up to 50 wt-%, up to 40 wt-%, or up to 30 wt-%, based on the total weight of the polymeric component of the (final) foamed composition. If used, one or more secondary polymers is present in the polymeric component in an amount of at least 10 wt-%, at least 20 wt-%, at least 30 wt-%, at least 40 wt-%, or at least 50 wt-%, based on the total weight of the polymeric component of the (final) foamed composition.

In certain embodiments, the polymeric component includes a secondary polymer selected from the group of butanediol vinyl alcohol polymer or copolymer, starch, vinyl acetate/ethylene copolymer, polyvinyl acetate, polyvinyl alcohol, dextrin stabilized polyvinyl acetate, vinyl alcohol/vinyl acetate copolymer, vinyl alcohol/vinyl acetate/ethylene copolymer, stabilized polyvinyl acrylate copolymer, vinyl (methyl)acrylic, styrene (meth)acrylic, (meth)acrylic, styrene butyl rubber, natural rubber, styrenic block copolymer, polyurethane, polyethylene, polyethyleneoxide, polyethylene glycol, polyacrylic acid, polymethacrylic acid, polyvinyl pyrrolidone, polyacrylamide, polypropylene glycol, polypropylene oxide,—polylactic acid, polyglycolic acid, polycaprolactone, polybutylene succinate, polybutylene adipate terephthalate, cellulose, and mixtures or copolymers thereof. One such commercially available polymer is that available under the trade designation “DUR—O-SET” (Celanese, Florence, KY USA), a polyvinyl alcohol stabilized vinyl acetate ethylene (VAE) emulsion. In certain embodiments, the polymer can be neutral or contain charged monomers (anionic, cationic, zwitterionic). One such commercially available polyvinylalcohol polymer is that available under the trade designation “POVAL” and “MOWIFLEX” (Kuraray, Houston, TX, USA), a polyvinyl alcohol polymer. In certain embodiments, the polymeric materials are recycle-compatible. In other embodiments, the polymeric materials are biodegradable. In yet other embodiments, the polymeric materials are compostable.

In certain embodiments, a foamed composition is formed from a foamable water-containing composition that includes a solids content (i.e., anything other than water or solvent) of at least 20 wt-%, at least 35 wt-%, or at least 50 wt-%, based on the total weight of the foamable composition prior to foaming. In certain embodiments, the foamed composition is formed from a water-containing composition that includes a solids content of up to 70 wt-%, or up to 45 wt-%, up to 35 wt %, based on the total weight of the foamable composition prior to foaming. The solids include the polymeric component, and any solid foaming agents (or solid residues remaining after foaming), fillers, and other optional solid additives. In certain embodiments, the foamed composition is formed from a foamable water-containing composition that includes a foaming agent, such as expandable microspheres. Although these are not required as other mechanisms of foaming are possible, as discussed below, if they are used, the expandable microspheres are present in an amount of up to 20 wt-%, or up to 15 wt-%, based on the total weight of the composition prior to foaming. In certain embodiments, if they are used, the expandable microspheres are present in an amount of at least 0.5 wt-%, based on the total weight of the composition prior to foaming.

In certain embodiments, the expandable microspheres are heat expandable polymeric microspheres. That is, the expandable microspheres are capable of expanding in size in the presence of heat and/or radiation energy (including, for example, microwave, infrared, radiofrequency, and/or ultrasonic energy).

The expandable microspheres have a particular temperature at which they begin to expand (initial expansion temperature or T₀) and a second temperature at which they have reached maximum expansion (maximum expansion temperature or Tₘ). Different grades of microspheres have different onset expansion temperature and maximum expansion temperature. For example, one particularly useful microsphere has a T₀ of 100° C. to 150° C. The temperature at which the microspheres have reached maximum expansion (T) is desirably from 100° C. to 200° C. Although the choice of the particular microspheres and their respective T₀ and Tₘ is not critical, the processing temperatures may be modified depending upon these temperatures. Before the composition is fully dried, these microspheres are able to move within the composition and are able to expand. Once the composition is fully dry, however, the microspheres are substantially locked in place. The expanded composition typically has a greater than 2000%, preferably greater than 2500%, total volume expansion from a wet or partially dry composition. There exists a relationship between the vaporization temperature of the solvent and the initial activation temperature of the microspheres (T₀). In most cases, solutions are water-based, thus the boiling or vaporization temperature of water is 100 degrees Celsius. By using expandable microsphere with a T₀ lower than 100 degrees Celsius, foam dots are produced with lower percent hollow core (as in Examples 108, 117, 118, and 119).

In certain embodiments, the expandable microspheres have a polymeric shell and a hydrocarbon core (e.g., a polyacrylonitrile or polyacrylonitrile copolymer shell.)

Suitable microspheres include, for example, heat expandable polymeric microspheres, including those having a hydrocarbon core and a polyacrylonitrile shell (such as those sold under the trade designation “DUALITE”) and other similar microspheres (such as those sold under the trade designation “EXPANCEL”, such as “EXPANCEL 043 DU 80”).

The expandable microspheres may have any unexpanded size, including from 5 microns to 30 microns in diameter. In the presence of heat, the expandable microspheres of the present invention may be capable of increasing in diameter by 3 times to 10 times. Upon expansion of the microspheres in the composition, the composition becomes a foamed material. Alternatively, the expandable microspheres can be pre-expanded before combining with the polymer component and fully expanded without a need to undergo further expansion.

The foamed composition, and the water-containing foamable composition from which it is formed, may also include one or more additional optional additives. Examples of suitable optional additives include tackifiers (e.g., rosin esters, terpenes, phenols, and aliphatic, aromatic, or mixtures of aliphatic and aromatic synthetic hydrocarbon resins), plasticizers (other than physical blowing agents), nucleating agents (e.g., talc, silicon, or TiO₂), colorants (e.g., pigments, dyes), reinforcing agents, solid fillers (e.g., pearl starch, physically modified starch, chemically modified starch, glass microspheres, clay, cork, saw dust, sand, inorganic particles (e.g., ceramic or metal), organic particles (e.g., carbon black particles, wood pulp, nanocrystal cellulose, crosslinked polymeric particles that are insoluble in water such as polystyrene-divinylbenzene)), rheology modifiers, toughening agents, thickening agents (e.g., water-soluble cellulose ethers, fumed silica, thermoplastic starch, charged or uncharged synthetic polymers or oligomers that can be linear, branched, hyperbranched, dendritic, or star in structure), flame retardants, preservatives (e.g., biocide, 1,2-benzisothiazolin-3-one, 5-chloro-2-methyl-4-isothiazolin-3-one and 2-methyl-4-isothiazolin-3-one), antioxidants, defoamers, crosslinkers (to increase the structural integrity of the composition after the microspheres are expanded), waxes (e.g., paraffin wax, beeswax, synthetic polyethylene wax), stabilizers (e.g., UV stabilizers), anti-oxidants, anti-yellowing agents, humectants, accelerators, anti-static agents, anti-block, slip agents, and combinations thereof.

Optional release agents, sometimes referred to as low adhesion backside (LAB) coatings, can be added to the formulation to promote slip or reduce the coefficient of friction of the foam. These release agents can include the vinyl-silicone copolymers disclosed in U.S. Pat. No. 5,032,460 (Kantner et al.). Additional LAB release agent formulations can include long alkyl chain acrylic copolymers disclosed in U.S. Pat. No. 5,225,480. Preferably, the LAB used is water-dispersible and renders paper coatings that are uniquely recyclable. Other release agents can include waxes, nanoparticles, microparticles, talc, and calcium carbonate.

The optional additives may be used in various combinations and in amounts sufficient to obtain the desired properties for the foam being produced. Typically, one or more such additives are present in an amount of at least 0.05 wt-%, based on the total weight of the foamable water-containing composition (prior to foaming). In certain embodiments, one or more optional additives in an amount of up to 15 wt-%, up to 10 wt-%, or up to 5 wt-%, based on the total weight of the foamable water-containing composition (prior to foaming).

The foamable compositions of the present disclosure desirably have a viscosity which permits high speed printing/coating/spraying/spreading/overlaying or similar process to deposit onto a substrate. Useful ranges of viscosities include 300 to 100,000 cPs at 25° C., and desirably 1000 cPs to 70,000 cPs at 25° C., as measured with a rheometer at a shear rate of 0.1 to 1 l/sec (Hz) according to the Brookfield Viscosity Test in the Examples Section. In certain embodiments foam compositions are coated from solutions with a viscosity of at least 500 cP, at least 1000 cP, at least 1,500 cP, or at least 15,000 cP. In certain embodiments, foam compositions are coated from solutions with viscosities up to 25,000 cP, up to 15,000 cP, up to 10,000 cP, up to 5,000 cP. In certain embodiments foam compositions are coated from solutions with a viscosity ranges of 1,000 cP to 25,000 cP, or 1,000 cP to 15,000 cP, or 1,000 cP to 5000 cP.

Various methods of printing, coating, spraying, spreading, overlaying, or otherwise applying a foamable water-containing composition to a substrate may be used to form a foamed composition of the present disclosure. In particular, rotogravure printing methods may be used, as described in the Examples section.

Patterned rotogravure printing deposits solution drops ranging from at least 1 mm in diameter with a spacing between dots of at least 1 mm. The rotogravure print pattern can be tailored to deposit a solution in a variety of geometric shapes such as circles, ovals, rectangles, continuous or discontinuous lines. A substrate that is coated across the entire substrate will not result in the same foam structure as when discrete foam dots are coated and dried since it is believed that discrete dots are needed to generate foam bubbles having a hollow interior and a porous exterior shell.

Following application of a foamable water-containing composition by pattern coating as described herein to a substrate, the coated substrate is subjected to conditions that cause foaming of the foamable composition. This preferably includes exposing the coated substrate to an elevated temperature for a period of time effective to form a foam and adhere the foam to the substrate. In certain embodiments, the drying temperature is at or above the melting temperature of the polymeric component of the foamable composition. For a water-based solution, the preferred drying temperature can range from 130° C. to 200° C. with a drying residence time of 30 sec to 60 sec. Too low a temperature and/or too short a period of time for this step may result in a foam being formed, but the foam may not adhere sufficiently to the substrate or form a microstructure sufficient to provide cushioning or other desired function.

During drying of the foam composition, the surface of the deposited liquid dots under certain conditions can skin over the dot's surface. As the solution continues to dry and the solvent vaporizes under the skinned surface, pressure is created by the vaporizing solvent which pushes the skin surface up and away from the substrate, creating a bubble with a hollow core. The shell of the dot comprises a polymeric resin, expandable microspheres, and miscellaneous fillers which become a porous shell after drying is complete. The porous shell encapsulates the hollow core and attaches the foam to the substrate.

The porosity of the exterior shell is affected by the wt % expandable microsphere in the foam composition. The foam exterior shell porosity can be up to 50% porous, 60% porous, 70% porous, 80% porous, or even 90% porous. The foam shell porosity is preferably at least 1% porous, at least 10% porous, or at least 50% porous. Ranges between these limits are also within the scope of the disclosure. The thickness of the porous shell can be important to overall mechanical stability of the porous shell hollow core foam dot. Foam dots with too thin of a shell will be detrimental to the foam's durability. Foam dots typically have porous shells that are at least 100 microns, at least 50 microns, or at least 25 microns thick.

The hollow core contained within the foam bubble can have effects on the resulting foam properties. For a given drop size, the larger the hollow core, the larger the overall foam dot for all dimensions (height, width, and length). The hollow core enlarges during drying while the shell wall thins. The size of the hollow core can be influenced by variables such as foam solution % solids, drying conditions, solvent type and/or blend, and aspect ratio of the deposited droplet.

In the combination of a porous shell and a hollow core foam structure, the size of foam bubble printed, the density of foam pattern, the bubble shape, the bubble height, the bubble diameter, and the shell thickness all play a role in determining the resulting material properties.

In certain embodiments, the hollow core has a volume of at least 0.2 mm³, at least 3 mm³, or at least 56 mm³ as determined by optical microscopy or x-ray tomography. In other embodiments the hollow core has a volume up to 56 mm³, up to 10 mm³, or up to 3 mm³ as determined by optical microscopy or x-ray tomography. The hollow core volume can be from 0.2 mm³ to 250 mm³, 5 mm³ to 100 mm³, or 10 mm³ to 50 mm³.

In other embodiments, the total foam bubble volume is at least 0.2 mm³, at least 10 mm³, at least 50 mm³, at least 70 mm³, or at least 125 mm³ as determined by optical microscopy or x-ray tomography. In other embodiments the total foam bubble volume is up to 400 mm³, up to 300 mm³, or up to 200 mm³. Ranges between these values are within the scope of the disclosure such as 0.2 mm³ to 400 mm³. Based on the hollow core volume and the total foam bubble volume, a percentage of the hollow core as a function of the total volume can be determined and suitable percentage ranges using the above ranges for hollow core volume and total foam bubble volume are within the disclosure.

The bubble shell provides some of the physical properties imparted in the foam such as seam strength, coefficient of friction, cushion properties, and abrasion resistance. For a given polymeric system, as the shell thickness increases, properties such as seam strength, and cushioning may be improved. Other physical properties such as coefficient of friction may be influenced by the polymeric resin chosen and the loading, type, and degree of expansion of microspheres in the shell, which in turn can affect the shell thickness.

In certain embodiments, the shell thickness ranges from 0.04 mm to 0.94 mm, more preferably from 0.15 mm to 0.75 mm, and more preferably from 0.2 mm to 0.55 mm. In certain embodiments the porous shell has a thickness of at least 0.1 mm, at least 0.2 mm, or up to 1.0 mm. In some embodiments, the foam exterior shell porosity is at least 10% porous, at least 25% porous, at least 50% porous, at least 60% porous, at least 70% porous at least 80% porous, or at least 90% porous, or at least 95% porous. Ranges between these values such as 60% to 90% porous are within the scope of the disclosure. In some embodiments the total porosity of the foam dot (hollow core+porous exterior shell) is at least 50% porous, at least 60% porous, at least 70% porous, at least 80% porous, at least 95% porous, or up to 99% porous.

Shell porosity is affected by the amount of microsphere loading of the dry composition. In certain embodiments, the microsphere wt-% of total dried foam composition ranges from 1 wt-%-12 wt-%, more preferably, 1 wt-% -6 wt-%, more preferably 1 wt-% -4 wt-%.

The foam height is a critical factor in controlling cushion behavior. Foam height in combination with the foam mechanical properties can affect the overall cushioning behavior. Generally, thicker foam gives an overall longer stopping distance for an object when dropped. Assuming the foam material has the proper compression properties for the range of weights, then thicker materials can provide better protection.

However, this must be balanced with a number of other considerations in the intended application such as cost and bulk. Therefore, it is preferred to not have a thicker foam material than is necessary to protect the item. In certain embodiments, the foam bubble has a height ranging between 0.5 mm and 30.0 mm, ranging between 1.0 mm and 12 mm, ranging between 2.0 mm and 6 mm, more preferred range between 1.0 mm and 3.0 mm.

The article in some embodiments may be recyclable, compostable, and/or biodegradable. In many cases the substrate the foam is coated on is paper-based and is inherently recyclable, compostable, and biodegradable. Foam coatings may reduce packaging articles compatibility with these processes. It therefore may be important to balance the amount of foam deposited onto the substrate in order to keep the final article recyclable, compostable, and/or biodegradable for some applications.

The amount of foam that can be put on will vary depending on the chemistry selected. In certain embodiments, the basis weight of the coating ranges between 5-90 gsm, more preferably between 20-60 gsm, or between 30-60 gsm, and most preferred between 25-55 gsm. In some embodiments, the basis weight is at least 30 gsm, or at least 55 gsm.

In certain embodiments, the basis weight of the dried foam coating is equal to the basis weight of the substrate. In certain embodiments, the basis weight of the coating ranges from 1-90% of the basis weight of the substrate, 2%-50% of the basis weight of the substrate, more preferably 5%-25% of the basis weight of the substrate

The fact that this foam structure can have a hollow core, and a porous exterior shell allows for a larger overall volume of material to appear after coating and drying. The size of the hollow core can vary widely depending on the solution solids, pattern used to coat, and other parameters contained within this application. In certain embodiments the % volume that the hollow core relative to the total bubble volume ranges from 5-99% of the total bubble volume, or between 10-70% or the total bubble volume, more preferably ranges between 10-50% of the total bubble volume.

### Coated Substrates

The present disclosure provides a coated substrate that includes a sheet material with a surface having disposed thereon a foamed composition as described herein. Such coated substrates can be used in packaging materials to provide padding and impart one or more of the following properties to a foam padded material or packaging article: impact protection; cushioning; thermal insulation; compression resistance; water resistance; recyclability; biodegrability; and/or compostability.

Examples of suitable substrates include woven materials such as fabric or textile and nonwoven materials. In some embodiments, the woven or nonwoven material uses materials such as cotton, linen, and other natural fibers. In some embodiments, the woven or nonwoven material uses synthetic, organic, or nonorganic material such as polyester, polylactic acid, polyethylene, polypropylene, carbon fiber, glass fibers, or wood fibers. In some embodiments, the substrate comprises cellulose fibers (e.g. paper). Other examples of suitable substrates include film sheets using natural or synthetic material such as polymeric films (including, but not limited to, polyester, polyolefin, polylactic acid, vinyl, acrylic, and rubber), metal foils, or metallized polymer sheets.

In some embodiments, the film or paper substrate uses one or multiple surface modification treatment steps, such as corona treatment, plasma treatment, vapor deposition, chemical etching, or a chemical or polymeric coating. The suitable substrates can have a thickness being in the range of 1 mm to 5 cm. In some embodiments, the substrate is corrugated (such as paper cardboard). In certain embodiments, the substrate is a paper with elongation being in the range of 0.1-10%, as measured according to ASTM D882. In certain embodiments, the substate is a paper with puncture load at break being in the range of 1-50N, as measured according to ASTM D1306. In certain embodiments, the substrate is a paper with a tearing force of 1-300 grams as measured using the pendulum method (Elmendorf tear) according to ASTM D1922. It is believed these attributes of paper are important when using the foam coated substrate as a mailer or wrap to protect articles during shipping.

In certain embodiments, the coated substrate is optionally recyclable and/or compostable, and/or biodegradable foam padded material suitable for use in making packaging articles. More specifically, the foam padded material includes: a sheet material having a first and a second major surface, wherein the sheet material is optionally a recyclable material, compostable, or biodegradable material; and a foamed composition disposed on the first major surface of the sheet material, the foamed composition comprising: a polymeric component that forms a plurality of structures (dots) with hollow cores and porous exterior shells on the sheet material.

The foamed composition may form a continuous or discontinuous coating on the surface of the substrate (e.g., sheet material) or a combination of the two. In certain embodiments, the foamed composition is disposed in a discontinuous pattern comprising an array of discrete elements. Such discrete elements can be in the form of a wide variety of geometric shapes, such as squares, rectangles, triangles, spirals, lines, circles, and or combinations of the mentioned geometric shapes and the like.

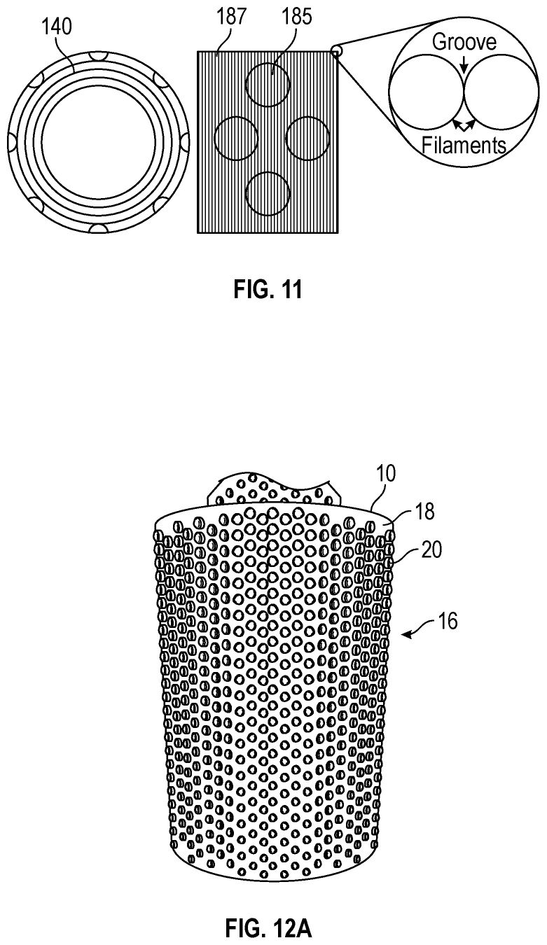

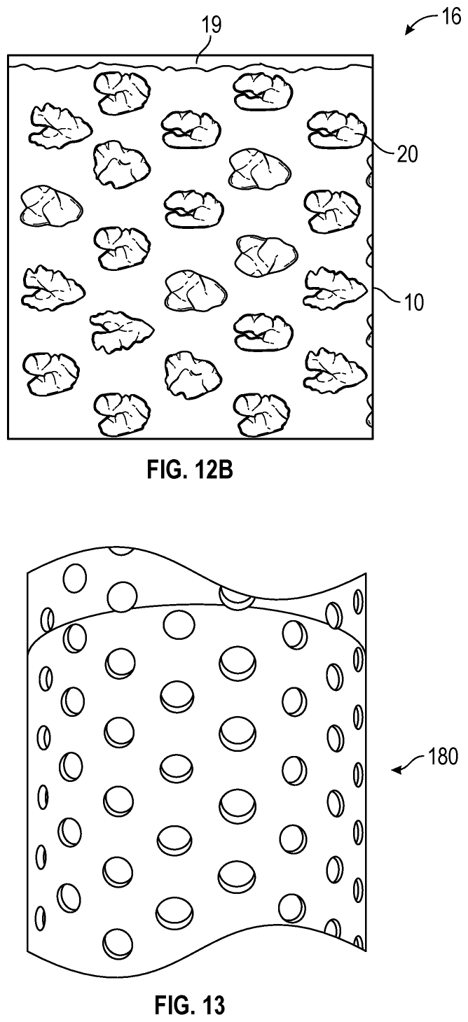

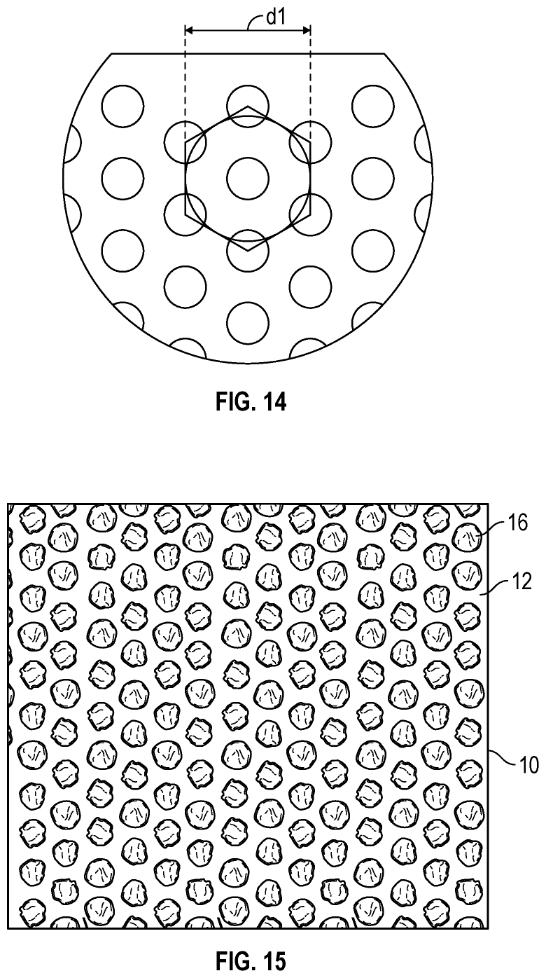

In other embodiments, the final foamed composition 16 can have a continuous or substantially continuous overall coating 18 on the first major surface 12 of the sheet material 10 and then a discontinuous pattern 20 comprising an array of discrete elements placed on top of the continuous coating, such as shown in FIGS. 12A and 12B. Utilizing both coatings layers can improve the heat-sealing capability of the foamed composition, since it has a continuous coating layer between the discrete foam dots or elements, while also having significant cushioning capability due to the discontinuous pattern coating layer. A rotogravure roll, as shown in FIG. 11, with appropriate cell patterns can apply both coating layers in a single printing pass. Alternatively, the different coating layers can be applied by two coating stations with different rotogravure rolls.

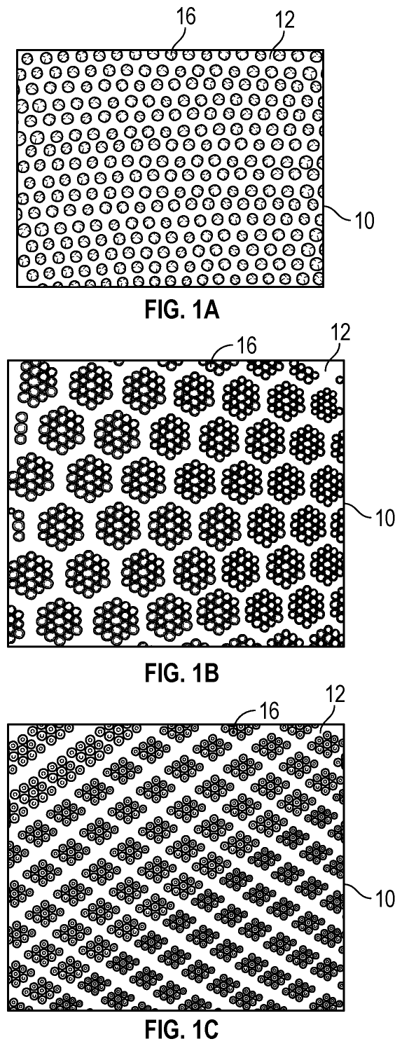

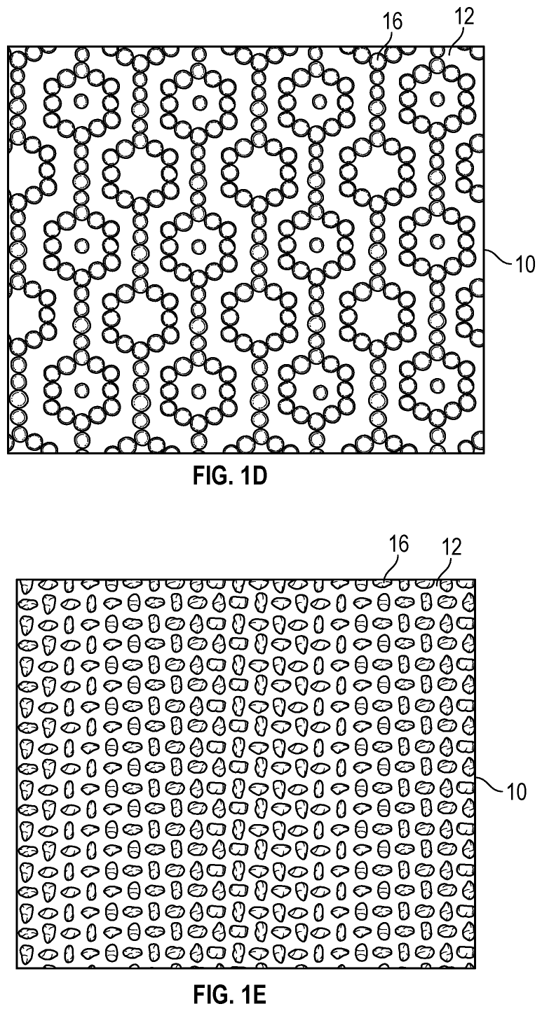

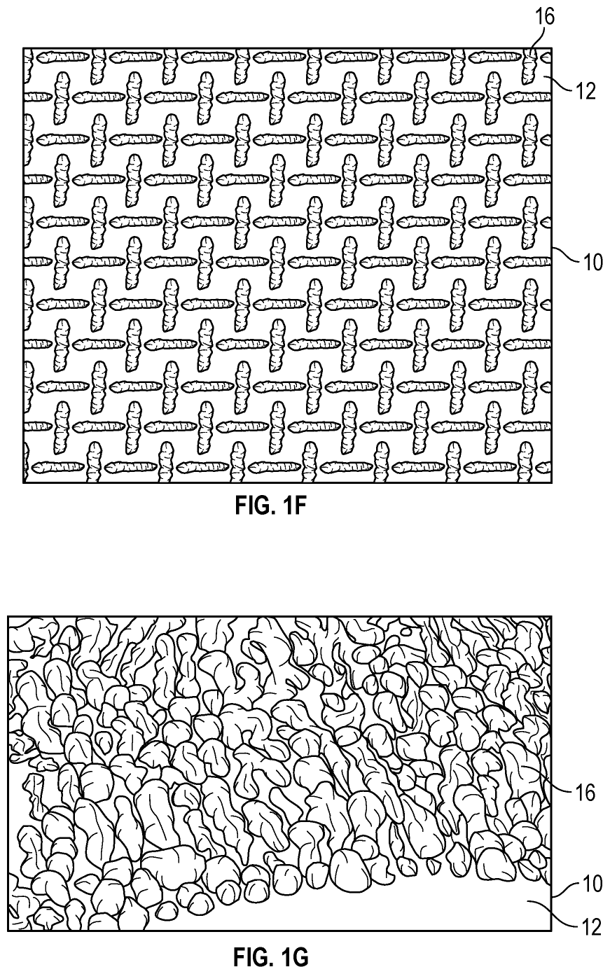

In a discontinuous pattern, spaces exist between the elements in the array of elements. The pattern is chosen to allow for appropriate expansion of the expandable composition upon depositing on the substrate surface. Any chosen pattern may include one or more variations of spacings for expansion. For example, discrete areas of the composition may be used, which are unconnected or discontinuous to other discrete areas of the composition; or discrete areas of the expandable composition may be used in combination with connecting bridges between the discrete areas, such that they are connected but still provide expansion room. The discrete areas may be any shape or configuration to serve the purpose of providing a protective padding upon expansion. Such patterns may be regular or irregular (i.e., with a random array of elements). Nonlimiting examples of such patterns are shown in FIGS. 1A-1G. The pattern may be configured in various ways to fit the final product and provide the desired padding. For example, the pattern may be a series of linear or nonlinear spaced apart elements of the composition. These elements may be connected at one or more places or may be positioned in a parallel or nonparallel configuration or may form recognizable texts, images or logos, for example.

Each element of the array of discrete elements of foamed composition has a length and a width, typically with at least one dimension being in a range of 0.05 inch to 2.0 inches, (1.27 to 50.8 mm) and at least one dimensions being in a range of 0.1 inch to 2.5 inches (2.5 to 63.5 mm). In some embodiments the foamed composition may have a diameter from 0.5 mm to 10 mm, or from 3 mm to 5 mm.

In some embodiments, the shell thickness can be from 0.02 mm to 2 mm, or 0.2 mm to 1 mm, or 0.2 mm to 0.5 mm.

The substrate surface area may be 100% covered, but typically is less than 100% covered, by the discrete elements of the foamed composition (i.e., foam). In certain embodiments, the foamed composition covers at least 5%, at least 10%, at least 15%, at least 20%, at least 30%, at least 40%, or at least 50% of the surface area of the substrate (e.g., sheet material). In certain embodiments, the foamed composition covers 100%, or less than 95%, less than 90%, less than 85%, less than 80%, less than 70%, or less than 60%, of the surface area of the substrate (e.g., sheet material). Ranges between these limits are within the scope of the invention. The coverage may be higher in certain areas than in others. For example, the coverage may be higher in an area on the substrate that will form a seal with another substrate (e.g., at edges of sheet materials that form the walls of an envelope). Alternatively, the coverage may be lower, or completely absent, in an area on the substrate (e.g., on a sheet material portion that forms a flap of an envelope).

In certain embodiments, the foamed composition is disposed on the surface of the substrate (e.g., sheet material) in an amount (i.e., coating weight) of at least 5 grams per square meter (gsm), at least 10 gsm, at least 15 gsm, or at least 20 gsm, at least 30 gsm, at least 40 gsm, at least 50 gsm. In certain embodiments, the foamed composition is disposed on the surface of the substrate (e.g., sheet material) in an amount of up to 120 gsm, up to 110 gsm, up to 100 gsm, up to 90 gsm, up to 80 gsm, up to 70 gsm, up to 60 gsm, up to 50 gsm, or up to 40 gsm. Ranges between these limits are within the scope of the disclosure such as 10 gsm to 120 gsm. This can be determined using the Foam Weight Test described in the Examples section. In certain embodiments, the foam composition is disposed on the surface with a coating weight between 20 gsm to 60 gsm, 25 gsm to 55 gsm, or 25 to 45 gsm

In other embodiments where there is both a continuous foamed composition coating layer and a discontinuous foamed composition coating layer of discrete elements, the coating weight range of the continuous foamed coating can be from 0-50 gsm, from 5-30 gsm, or from 5-20 gsm. The weight range of the discontinuous discrete foamed elements can be from 5-100 gsm, from 10-80 gsm, or from 15-70 gsm. The total coating weight on the substrate would be the sum of the individual weight ranges.

In certain embodiments, the foamed composition (i.e., each element of the array of discrete elements of foamed composition) disposed on the surface of the substrate (e.g., sheet material) has a height of at least 0.25 mm, at least 0.5 mm, at least 1.0 mm, at least 2 mm, and often up to 10 mm or even up to 50 mm.

In certain embodiments, the foamed composition (i.e., each element of the array of discrete elements of foamed composition) is disposed on both opposing surfaces of the substrate (e.g., sheet material). The patterns on opposing surfaces may include the same pattern used on both surfaces, different patterns on opposing surfaces, or one surface may be discontinuous and the opposing surface be a discontinuous and/or continuous coating. The foamed compositions may be exposed, or they may be covered or enclosed (at least partially) by one or more sheet materials (e.g., paper or other cover sheet) such that the foam padding material forms a “sandwich” with the foamed composition sandwiched between two sheet materials, which may be the same or different. Such foam padded materials may include, for example, paper/foam/paper or paper/foam/foam/paper constructions, and may be used in making multilayered padded mailing articles. Instead of paper another sheet material may be substituted such as a nonwoven or film.

The recyclable and/or compostable padding material can be provided in any size or shape. Typically, it is provided in a roll form that can be easily cut into discrete lengths for forming into a packaging article, e.g., an envelope or a shipping wrapping that is placed around the shipping article to protect it.

### Sheet Materials

In some embodiments, the sheet materials of the foam padded materials and the walls of the packaging articles include biodegradable materials. In certain embodiments the biodegradable material is paper. In other embodiments, the sheet materials may be biodegradable polymers such as polyvinyl alcohol, polybutylene succinate, polysaccharides, polylactic acid, polyglycolic acid, or blends or copolymers. In certain embodiments, the sheet materials of the foam padded materials and the walls of the packaging articles include recyclable materials. In certain embodiments, the recyclable materials are repulpable materials, such as paper. In some embodiments, the sheet materials of the foam padded materials and the walls of the packaging articles contain only repulpable paper, and thus are described as consisting of repulpable paper. The sheet materials of the foam padded materials and the walls of the packaging articles can be one material or more than one material, and the materials that constitute the first and second walls can be the same or different.

“Paper” as used in this context refers to woven or non-woven sheet-shaped products or fabrics (which may be folded and may be of various thicknesses) made from cellulose (particularly fibers of cellulose, (whether naturally or artificially derived)) or otherwise derivable from the pulp of plant sources such as wood, corn, grass, rice, and the like. Paper includes products made from both traditional and non-traditional paper making processes, as well as materials of the type described above that have other types of fibers embedded in the sheet, for example, reinforcement fibers. Paper may have coatings on the sheet or on the fibers themselves.

Any form of paper can be employed, although it is preferred that the paper is repulpable (i.e., capable of being turned into pulp). Papers (or cellulosic fibers) are by nature pulpable but once the papers are treated, their recyclability depends on the amount of fibers separated during the repulping process; for example, in the USA, there is a Volunteer Standard specifying a minimum of 85% fibers recovery. This standard was created by a joint committee of the Fibre Box Association and the American Forest & Paper Association (AF&PA).

In certain embodiments, the sheet material is a woven or nonwoven web, for example a spunbond or meltblown. In some embodiments, the woven or nonwoven material consists of natural materials such as cotton, linen, and other natural fibers. In some embodiments, the woven or nonwoven material consists of synthetic, organic, or nonorganic material such as polyester, polylactic acid, polyethylene, polypropylene, carbon fiber, glass fibers, or wood fibers. In some embodiments, the substrate consists of cellulose fibers (e.g. paper).

In certain embodiments, the sheet material is a film. Examples of suitable substrates include film sheets consisting of natural or synthetic material, such as polymeric films (including but not limited to polyester, polyolefin, polylactic acid, vinyl, acrylic, and rubber), metal foils, or metallized polymer sheets. In some embodiments, the film or paper substrate consists of one or multiple surface modification treatment steps such as corona treatment, plasma treatment, vapor deposition, chemical etching, or a chemical or polymeric coating.

Exemplary paper sheet materials include Kraft liner paper, fibreboard, chipboard, corrugated boards, paper medium, corrugated medium, solid bleached board (SBB), solid bleached sulphite board (SBS), solid unbleached board (SLB), white lined chipboard (WLC), kraft paper, kraft board, coated paper, internally sized paper, binder board, or mixtures thereof. Examples of non-traditional products that are “paper” within the context of this disclosure include the material available under the trade designation “TRINGA” from PAPTIC (Espoo, Finland), and sheet forms of the material available under the trade designation “SULAPAC”. Kraft paper is particularly useful for this purpose, although other papers may be used.

Exemplary sheet materials that can be used have a basis weight that is sufficient to allow them to withstand weather conditions, such as heat, cold, rain, or snow, and other conditions and that may be encountered during a packaging and shipping process, as well as to withstand handling that may occur during packaging and shipping, such as dropping, jostling, banging against other objects, and the like. Any basis weight that is suitable for the intended use can be employed, and a variety of basis weights may be suitable depending on the needs of the users. Most commonly, the basis weight (in units of grams per square meter (g/m 2 or gsm)) will be at least 5, at least 10, at least 15, at least 20, at least 25, at least 30, at least 40, at least 45, at least 50, at least 55, at least 60, at least 65, at least 70 gsm. Most commonly, the basis weight (in units of g/m 2 (gsm)) will be up to 200, up to 150, up to 140, up to 130, up to 120, up to 110, up to 100, up to 75, up to 70, up to 65, up to 60, up to 55, up to 50, up to 45, up to 40, up to 35, up to 30, or up to 25 gsm. Most commonly, the basis weight employed (in units of g/m 2) is 30 to 200 gsm.

In particular cases, a single sheet of material is folded to create both the first wall and the second wall out of the same sheet of material, which provides a first wall and a second wall that have the same constituents and are made of the same materials. This can be particularly advantageous for ease of assembly or manufacture of the packaging article such as an envelope, mailer, or tube. In such embodiments, it may be preferred to leave the fold line and/or sealing line uncoated with the foamable composition. FIG. 21 shows a sheet material 10 having a foamed composition 16 disposed on the first major surface in two main areas and having an uncoated folding or seaming region 31 running the length of the sheet material such that when it is folded in half, the foamed composition 16 does not impede the folding operation on the packaging equipment and a crisp fold line is formed.

In some embodiments, one end or edge of the sheet can overlap the opposing end or edge of the sheet, forming a tube. The tube can be sealed by attaching the overlapping portions. The resulting tube can be open at both ends. It is possible to seal both of the final two openings after an object is placed within the packaging article, or it is possible to seal one opening, then place an object within the packaging article, and then seal the remaining opening. This can be accomplished by methods described herein or known in the art, for example, by use of a bag sealing machine, impulse sealer, heat sealer, or the like.

It is not required that the first wall and second wall be made of the same sheet of material. It is also possible to attach two sheets of different materials to make an article with a first wall and second wall that have different materials, such as a paper and a polymer film. This can be advantageous for some intended uses so embodiments that are assembled in this manner are also important. It is also possible to attach two sheets of the same materials rather than folding one sheet; while this is less common, it may be an important mode of practicing the disclosure for some intended uses of the packaging article.

The first wall, second wall, or both may be constructed from a single layer or sheet of material or from multiple sheets.

When multiple sheets (i.e., layers) are used for the first wall, second wall, or both, they can be the same or different layers or sheets. Two, three, four, or even more layers or sheets can be used. In a configuration where there are two layers or sheets, one sheet is an inner layer or sheet disposed on the interior of the applicable wall, and the other layer or sheet is an exterior layer of sheet disposed on the exterior of the applicable wall. In a configuration where there are three layers or sheets, an additional intermediate layer or sheet is present between the inner and outer layers or sheets. The foamable composition can be disposed between any of sheets and/or on the interior surface and/or on the exterior surface of the sheets forming the wall.

One or more of the layers or sheets can be flat layers or sheets. It is also possible that one or more of the layers or sheets can be embossed (prior to depositing foam thereon). An embossed layer or sheet can provide some additional cushioning for the contents of the packaging article, and so can be advantageous for certain uses. Any embossment pattern can be used, but most often a regular or repeating pattern is employed. Examples of repeating patterns are diamonds, squares, circles, triangles, hexagons, as well as mixed patterns with different shapes. When multiple layers or sheets are used, any or all of the layers or sheets can be embossed. Most commonly, when two layers or sheets are used the interior layer or sheet is embossed and the exterior layer or sheet is not embossed. When three layers or sheets are used, then typically either the intermediate or interior layer or sheet is embossed and the other layers or sheets are not embossed. However, other configurations are possible. For example, it might be useful in a three-layer construction to emboss both the interior layer or sheet and the intermediate layer or sheet in order to provide additional cushioning beyond what is provided with only one embossed layer or sheet.

Any of the layers or sheets may include a coating, which is deemed to be part of the layer or sheet. Suitable coatings, which may be selected depending on the requirements or ultimate intended use of the article, can include polyester, poly(butylene succinate), poly (butylene succinate adipate), silicone, fluorinated polymer, acrylics, acrylates, poly(ethylene succinate), poly(tetramethylene adipate-co-terephthalate), castor wax, or thermoplastic starch, particularly at least one of poly(butylene succinate), poly (butylene succinate adipate), poly(ethylene succinate), castor wax, or poly(tetramethylene adipate-co-terephthalate), more particularly poly(butylene succinate), castor wax, or both poly(butylene succinate) and castor wax, and most particularly poly(butylene succinate).

### Packaging Articles

Packaging articles, particularly those designed for shipping, such as mailers, envelopes, bags, pouches, and boxes, are described herein. Packaging articles can also be in the form of cushion materials or wraps where an item is wrapped with one or more layers of the sheet materials in order to provide a protective cushion around an item to be shipped within another packaging article such as a box. Alternatively, the material forming the box may be coated so as to have a cushioning layer on either the inside or the outside of the box or both and the foamable composition can in some embodiments serve to heat seal the flaps of the box closed.

The packaging article can take a variety of forms. For example, the article can be a pouch, a bag, a box, a mailer or an envelope. Still other forms are also possible. Regardless of its form, the article can be completely closed, for example with an object inside it, or it can have an opening. The article will typically have two walls, a first wall and a second wall, each having an interior surface facing the interior of the article and an exterior surface facing the exterior of the article. Thus, the interior surface of the first wall (the “first interior surface”) faces the interior surface of the second wall (the “second interior surface”).

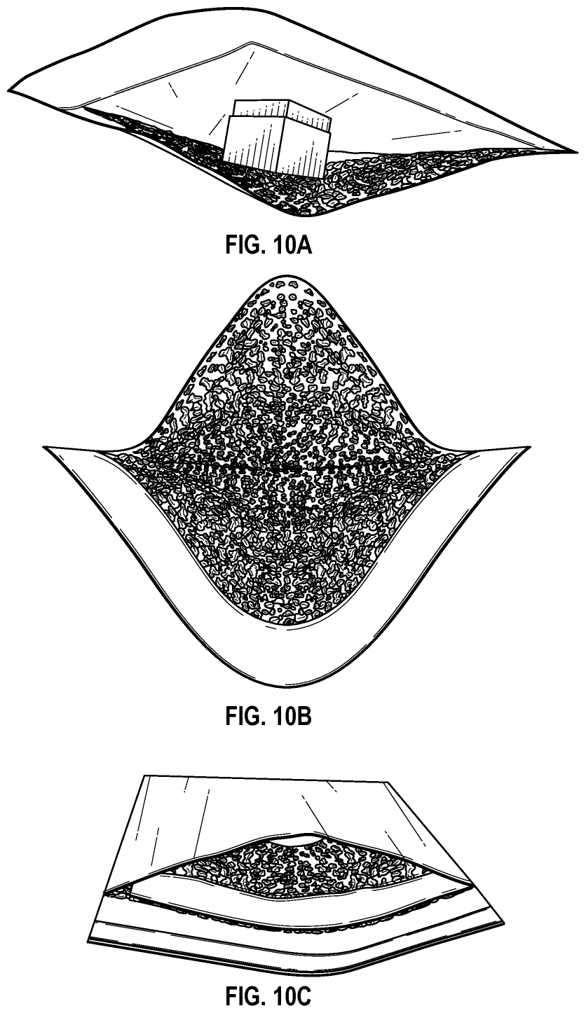

The interior surfaces of the walls, which as discussed above may be coated surfaces, are the surfaces of the sheet materials that include the foamed composition disposed thereon. The foamed composition can be exposed to the interior of the packaging article, in which case no further sheets or layers are disposed over the foamed composition. Alternatively, one or more further layers of sheet material can be disposed over the foamed composition in the form of one or more cover sheets. In those cases, the packaging article has a construction with the foamed composition sandwiched between two sheets or layers of materials. The cover sheets can comprise the same or different materials from the materials that make up the walls. Such walls may include one layer of foam-coated sheet material plus a cover sheet or two layers of foam-coated sheet material, thereby forming, for example, paper/foam/paper or paper/foam/foam/paper constructions. Examples of such multilayered padded mailing articles are shown, for example, in FIGS. 10A-C. Such cover sheets may reduce the friction experienced by items inserted into a padded mailing article.

The two walls are typically made from a sheet of material, which may be a single layer of material or multiple layers of material. Each of the walls may be made of different sheets, in which case the two walls can be made from the same or different material. More commonly, the first and second walls are made of the same sheet of material that is folded to produce the two distinct walls. In these cases, the first and second walls can consist of the same materials.

The first wall and the second wall are attached along at least one edge of the packaging article. Depending on the configuration and shape of the article, they may be attached along two, three, four, or even more edges. The first wall and the second wall can be attached directly, such as being sealed together, or they may be attached indirectly by way of an intermediary structure such as a gusset, welt, or similar. The packaging article can also include an opening where the first and second walls are not attached.

The packaging article can include an opening where the first and second walls are not attached. However, openings are not required because it is also possible to form the packaging article around an object located in the interior thereby removing the need to make an article with an opening and subsequently close the opening.

The packaging articles include a foamed composition disposed on at least a portion of each of the first and second interior surfaces. The foamed composition may form a continuous or discontinuous coating on each of the first and second surfaces. In certain embodiments, the foamed composition is disposed in a discontinuous pattern comprising an array of discrete elements. Such discrete elements can be in the form of a wide variety of geometric shapes, such as squares, rectangles, triangles, spirals, lines, circles, and the like. The spacing, size, density, etc. of the foamed composition that is disposed on the interior surfaces of the packaging article can be the same as described herein for the foam padded material.

When employed, the one or more cover sheets disposed over the foamed construction can be made of any suitable sheet material or layer. Most commonly, cover sheets are made from a paper or nonwoven sheet or layer. When paper is used, the paper can be any type of paper, which will depend on the intended use, such as Kraft paper, white paper, crepe paper, and the like. When a nonwoven is used, it can be any sheet nonwoven, such as those made of polymers or copolymers of one or more of lactic acid, lactide, glycolic acid, glycolide, caprolactone, and the like. The one or more cover sheets can be coated on one or both sides, for example, with heat sealable coatings that can include, for example, poly(butylene succinate), poly (butylene succinate adipate), silicone, fluorinated polymer, acrylics, acrylates, poly(ethylene succinate), poly(tetramethylene adipate-co-terephthalate), castor wax, or thermoplastic starch, particularly at least one of poly(butylene succinate), poly (butylene succinate adipate), poly(ethylene succinate), castor wax, or poly(tetramethylene adipate-co-terephthalate), more particularly poly(butylene succinate), castor wax, or both poly(butylene succinate) and castor wax, and most particularly poly(butylene succinate).

When employed, the one or more cover sheets can be secured in place either by anchoring to the all or part of the foamed composition or, in cases where not all of the interior surface of the wall is covered by a foamed composition by anchoring to one or more portions of the interior surface of the wall that do not contact the foamed composition. This can be accomplished by laminating, heat sealing, adhesive, or the like, or, in the case where a cover sheet is anchored to the foam, by using the foamed composition itself as an adhesive, which can be accomplished by contacting a cover sheet with the foamed composition while the foamed composition has not completely set.

One or more cover sheets can be used. When cover sheets are employed, most commonly the interior surfaces of both walls are covered by the cover sheets. However, this is not required. It is to be understood that the use of cover sheets is optional.

The packaging articles of the present disclosure also include a sealing joint at one or more edges of the first and second walls. In most cases the sealing joint includes, or is formed from, the foamed composition, which attaches the first wall to the second wall.

In making a packaging article, the sheets can be bonded together in any suitable way to form a sealing joint at one or more edges of the sheet materials (e.g., that form the first and second walls of the packaging article). Preferably, the sealing joint can be formed using the foamed composition to attach the first wall to the second wall. Preferably, the foamed compositions as described herein can be heat-sealable compositions, in which case the sheets can be bonded together by a heat-sealing process, induction welding, ultrasonic welding, or impulse sealing. A patterned calendar roll or pressured roll can also be used to bond adjoining layers. Alternatively, the foamed compositions can be water-sealable compositions, thereby form a sealing joint upon the application of water.

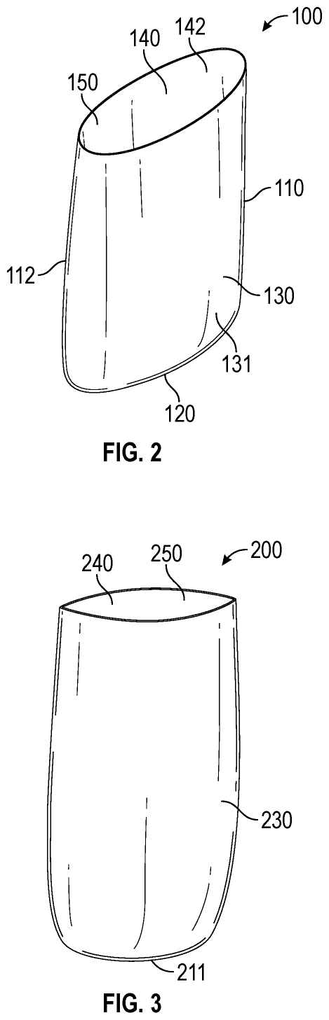

FIG. 2 shows one exemplary packaging article construction where two edges of the first and second walls are attached. In FIG. 2, article 100 is configured as a bag. First and second edges 110, 112 are attached directly, joining first wall 130 with second wall 140. Only the exterior surface 131 of first wall 130 and interior surface 142 of second wall 140 are visible in this figure. Opening 150 is present where the first and second walls 130, 140 are not attached. Bottom 120 is in this case defined by a fold in the sheet material that constitutes article 100.

FIG. 3 shows another construction where only one edge of the first and second walls are attached. Here, exemplary article 200 is also configured as a bag. A single edge 211 attaches most of first and second walls 230, 240 while leaving them unattached at opening 250.

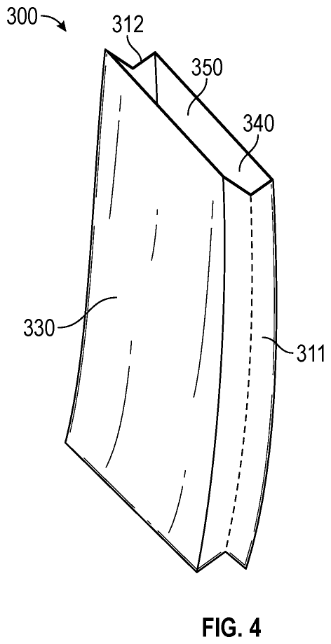

FIG. 4 shows a construction of exemplary packaging article 300 where edges 311, 312 are in the form of gussets that attach first and second walls 330, 340 while leaving opening 350 where the first and second walls 330, 340 are not attached.

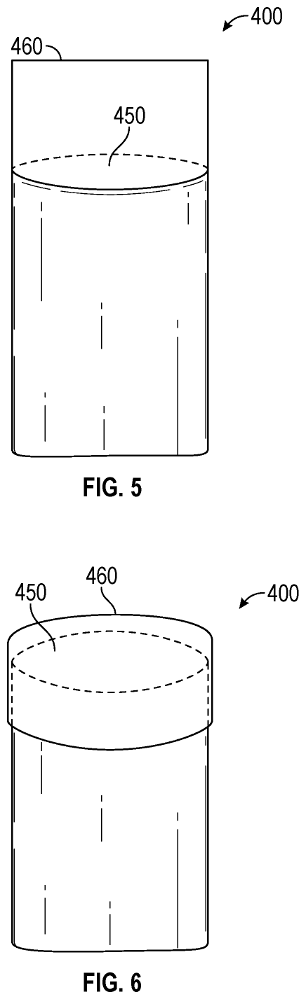

FIGS. 5 and 6 show another exemplary construction of packaging article 400, which contains flap 460, which is foldable between an open position, as shown in FIG. 5, and a closed position as shown in FIG. 6. In the open position opening 450 is uncovered, but in a closed position opening 450 is covered by flap 460.

### Adhesive Portions

In some embodiments, one or more adhesive portions can be provided. The adhesive portions are not considered to be part of the walls. Typically, when employed, the adhesive portions are near the opening in the packaging article and can be used to close the article. If a flap is employed, the one or more adhesive portions are often on the flap, or on a portion of the exterior surface that can be reached by the flap when the flap is folded into the closed position, so as to allow the flap to be adhered into a closed position. In many cases two adhesive portions are provided.

The one or more adhesive portions are usually in the shape of a strip or strips that runs roughly parallel to the opening of the packaging article, but this is not required. For example, it is also possible to coat the adhesive portion or portions over one or more larger sections or portions of the articles, such as sections or portions of one or more walls or the flap (if a flap is employed). The one or more adhesive portions can be any suitable adhesive depending on the desired use and are particularly recyclable, compostable, or recycle compatible, and most commonly recycle compatible. In this context, the term “recycle-compatible” refers to materials or compounds that are not themselves recyclable but that are readily separated from recyclable materials during the recycling process, more particularly during repulping. Thus, a packaging article can have components, such as adhesive, that are not themselves recyclable and still be recyclable if the non-recyclable components are recycle compatible.

In particular cases, the one or more adhesive portions consist of recyclable and/or compostable adhesive. The one or more adhesive portions can be a water-activated adhesive, a heat sealable adhesive, a hot melt adhesive, or a pressure sensitive adhesive. Most particularly, a pressure sensitive adhesive is employed. Examples of suitable adhesives include a copolymer of 2-octylacrylate and acrylic acid; a copolymer of sugar-modified acrylates; a blend of poly(lactic acid), polycaprolactone, and resin; a blend of; poly(hydroxyalkanoate) and resin; protein adhesive; natural rubber adhesive; synthetic rubber adhesive; and polyamides containing dimer acid.

When a heat sealable adhesive is used, it can be any heat sealable or hot melt adhesive. Most commonly the heat sealable adhesive is one that can be sealed at a moderate or low heat by use of an impulse sealer, or heat sealer, for example, a handheld heat sealer. Many handheld heat sealers are commercially available both for home and commercial use, for example the Mini Bag Sealer (available from EEX Co., Ltd.) and the iTouchless Handheld Heat Bag Sealer (available from Amazon, USA). Examples of heat sealable adhesives that can be used include poly(butylene succinate), poly (butylene succinate adipate), silicone, fluorinated polymer, acrylics, acrylates, poly(ethylene succinate), poly(tetramethylene adipate-co-terephthalate), castor wax, or thermoplastic starch, particularly at least one of poly(butylene succinate), poly (butylene succinate adipate), poly(ethylene succinate), castor wax, or poly(tetramethylene adipate-co-terephthalate), more particularly poly(butylene succinate), castor wax, or both poly(butylene succinate) and castor wax. Most particularly, poly(butylene succinate) (sometimes known as PBS) is employed.

One or more release liners can be disposed over any or all the one or more adhesive portions. While it is advantageous that the release liners be compostable and/or recyclable, this is not required because the release liners can be disposed of separately from the packaging article after use and do not have to be placed with the packaging article in a composting and/or recycling environment. Thus, if the packaging articles as described herein have one or more release liners, the packaging articles can be compostable and/or recyclable even if any or all of the release liners are not.

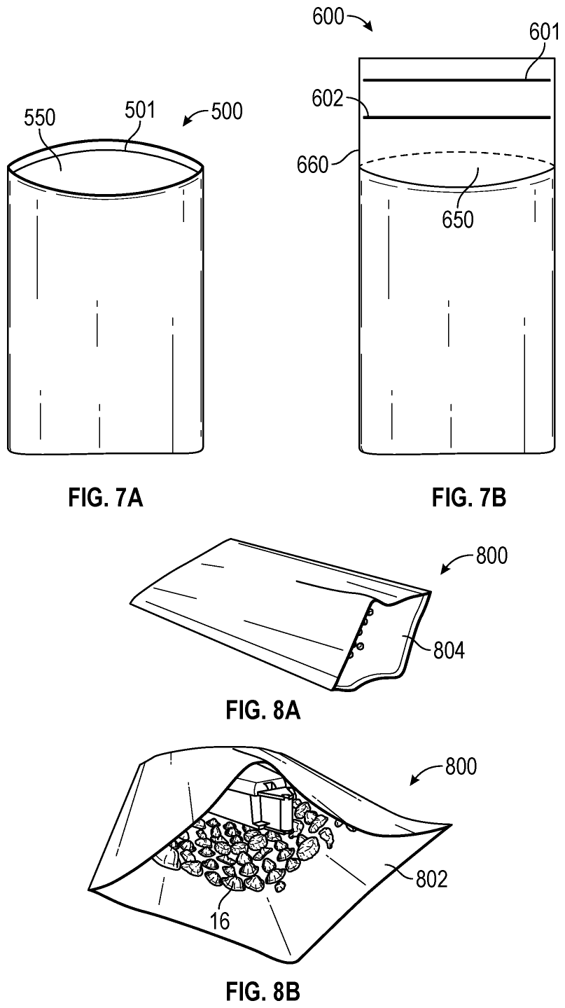

Exemplary packaging article 500 with adhesive portion 501 is shown in FIG. 7A. In this example, packaging article 500 is formed as a bag and adhesive portion 501 is disposed near the top of opening 550 to close opening 550 if desired.

Exemplary packaging article 600 with two adhesive portions 601 and 602 is shown in FIG. 7B. In this example, packaging article 600 is formed as a pouch and adhesive portions 601 and 602 are disposed on flap 660 to close opening 650.

FIGS. 8A and 8B are schematics of an exemplary packaging article, specifically an envelope with an uncoated flap (i.e., a portion of the wall material that forms the flap of the envelope with no foamed composition disposed thereon) having an adhesive strip disposed thereon for sealing of the flap when in a closed position.

When the article has one or more cover sheets, one or more adhesive portions can be on the cover sheets. For example, when a heat-sealable coating, such as poly(butylene succinate) is used as a coating on part or all of the cover sheets, the heat-sealable coating can serve as an adhesive portion.

### Mechanisms to Facilitate Opening

Mechanisms or features may be present to facilitate easy opening of the packaging article after it is sealed. Examples include perforations, scoring, zip-tops, or embedded pull-strings or wires. When an opening or flap is present, one or more of these features may be present near the opening or flap to facilitate opening the packaging article near the opening or flap, or they may be present on a different part of the packaging article. While these features, when employed, are most commonly in a straight line parallel to at least one edge of the packaging article no particular configuration is required; other shapes or layouts can be used depending on the intended use of the packaging article.

### Methods of Making and Assemblies

Assembly of the packaging articles as described herein can be performed by any suitable method.

One method of assembling the packaging article entails folding the one or more layers or sheets, which are bonded together when multiple layers or sheets are used, to form a first wall and a second wall. When the packaging article is a bag, they can be folded in half. When the packaging article is a pouch or envelope, they can be folded such that there is flap in the first wall that overhangs the edge of the second wall. The edges can then be attached, such as by heat sealing, ultrasonic welding, or impulse sealing, to form the packaging article. The procedure is similar when the first and second walls are made of different materials, as long as one wall has the foamed composition disposed therein, in which case all the edges besides the opening can be sealed to form the final article.

An assembly can be formed by placing an object in any packaging article as described herein. The packaging article can then be closed, for example, by folding the flap to a closed position and attaching it to an exterior surface with at least one of the one or more adhesive portions.

An assembly and packaging article can be formed together. For example, an object can be placed on the layers or sheets from which the article or assembly is to be formed. The article or assembly can then be folded around the object and the edges sealed completely around the object. This can result in an article or assembly wherein the object is in the interior of the packaging article or assembly, and the edges are sealed so that the object cannot fall out unless one or more seals are broken at the edges or one or more of the layers or sheets are punctured, cut, torn, or the like to make an opening

### Resealing

When one or more adhesive portions are used on the flap, it is possible to reseal an open packaging article. For example, an assembly can be formed as discussed above and the packaging article can then be opened, for example, by tearing the flap of the packaging article at the perforated sealed adhesive portion or by tearing a seal of the cover sheet or sheets. At this point, an adhesive portion is available to reseal the packaging article. This procedure can be followed, for example, when an item that is shipped within the packaging article is to be returned to the sender within the same packaging article.

### Examples

The following illustrative examples may aid in understanding the disclosure. However, the disclosure is not necessarily limited to these examples. Embodiments and concepts that are not specifically exemplified may have been disclosed. Unless otherwise noted, all parts, percentages, ratios, etc. in the examples and the rest of the specification are by weight, and all materials used in the examples were obtained, or are available, from general suppliers such as, for example, Georgia-Pacific, Atlanta, GA, US.

TABLE 1
Materials

| RM | Abbreviation | Description and Source |
|---|---|---|
| 1 | NICHIGO G | BVOH, obtained under the trade designation “NICHIGO, |
| | POLYMER OKS- | G POLYMER OKS-8074”, from Soarus L.L.C, Arlington |
| | 8074 | Heights, IL |
| 2 | POVAL 5-88 | PVOH, obtained under the trade designation “POVAL 5- |
| | | 88”, from by Kuarary America, Inc. Houston TX |
| 3 | DUR-O-SET | VAE, obtained under the trade designation, “DUR--O- |
| | | SET E130”, from Celanese Corporation, Irving TX |
| 4 | JONCRYL HPB 4030 | Polyacrylate, obtained under the trade designation |
| | | “JONCRYL HPB 4030”, from BASF Houston TX |
| 5 | POLYOX N80 | PEO, obtained under the trade designation, “POLYOX |
| | | N80, from Dupont Wilmington, DE |
| 6 | PVP-K30 | Polyvinylpyrrolidone, obtained under the trade |
| | | designation “PVP-K30”, from Ashland, Columbus OH |
| 7 | MOWIFLEX C17 | Mowiflex C17, obtained under the trade designation |
| | | “MOWIFLEX 17”, from Kuarary America, Inc. Houston |
| | | TX |
| 11 | EXPANCEL | Microspheres, obtained under the trade designation |
| | 043DU80 | “EXPANCEL 043DU80”, from Nouryon, Amsterdam, |
| | | The Netherlands |
| 12 | DUALITE U010- | Microshperes, obtained under the trade designation |
| | 130D | “DUALITE U010-130D”, from by Chase Corporation, |
| | | Westwood MA |
| 13 | DUALITE U010- | Microspheres, obtained under the trade designation |
| | 185D | “DUALITE U010-185D”, fromChase Corporation, |
| | | Westwood MA |
| 14 | EXPANCEL | Microspheres, obtained under the trade designation |
| | 951DU120 | “EXPANCEL 951DU120”, from Nouryon, Amsterdam, |
| | | The Netherlands |
| 15 | F2800D | Microspheres, obtained under the trade designation |
| | | “F2800D”, from Matsumoto Inc, Kitakyushu, Fukuoka, |
| | | Japan |
| 21 | 32N711 | Colorant, obtained under the trade designation “32N711”, |
| | | from PennColor, Doylestown PA |
| 22 | METHOCEL K4M | Rheology Modifier, under the trade designation |
| | | “METHOCEL K4M”, from Dupont Wilmington, DE |
| 23 | Silicone LAB Release | Vinyl-silicone copolymer type disclosed in U.S. Pat. |
| | Agent | No. 5,032,460. |
| 24 | LAB release agent | Long chain alkyl acrylic copolymer type disclosed in U.S. |
| | | Pat. No. 5,225,480 |
| 31 | Water | Deionized Tap Water |
| 32 | IPA | Isopropyl Alcohol |
| 41 | Paper | Product 085955. 55# paper with sizing has a basis weight |
| | | of 88.3 gsm, obtained from Ahlstrom Munksjo, Mosinee |
| | | WI, USA |
| 42 | Film | Polyethylene terephthalate film and polypropylene film |
| | | obtained from Loparex LLC, Cary, NC |
| 43 | Nonwoven | Nylon nonwoven - Nylon 6,6 spunbond/point bonded, |
| | | style PBNII 30200 with a basis weight of 68 gsm, |
| | | obtained from Cerex Advanceed Fabrics, Inc.. |
| | | Contonment, Florida |

### Test Methods

### Brookfield Viscosity:

Viscosity of the aqueous polymer dispersions was measured using a Brookfield DV-E Viscometer, while operating at 3, 10, or 30 revolutions per minute (rpm) using spindle #3.The actual spindle and rpm used is reported in tables 2,3, & 4.

### Foam Weight:

The weight of the foam was measured using TAPPI T 410 OM-19, “Grammage of Paper and Paperboard (Weight per Unit Area).” A 10-centimeter (10-cm) by 10-cm (4-inches (4-in) by 4-in) square was cut from each foamed sample and was weighed and the total basis weight in gsm (grams per square meter) was calculated. To determine the coating weight of the foam only, the basis weight of the substrate was subtracted from the total basis weight.

### Foam Dot Characterization:

Foam dots were characterized by optical microscopy. The shell thickness, dot diameter, dot height, foam dot volume, and hollow core volume and % hollow core volume were measured and calculated based on the following equations. The hollow core % volume ranged from 30-95% of the calculated volume. Total porosity of the samples was determined by x-ray tomography. An example of an optical micrograph from Example 101 is shown in FIG. 18.

Estimated bubble volume was calculated using the formula for the volume of a cylinder:

estimated bubble volume=\hat{ }πRₒᵤₜ²*height

Estimated core volume was calculated using the formula for the volume of a cylinder:

estimated core volume=(π(Rᵢₙ)²)*height
Rₒᵤₜ is the outer radius calculated as ½ *dot diameter in Table 13.
Rᵢₙ is the inner radius calculated as (½ *dot diameter)−(shell thickness) in Table 13.

### X-ray Microtomography Analysis:

A strip of material was cut from each provided sheet, such that at least one foam structure (bubble) was fully intact and adhered to a plastic support using double-sided tape to immobilize the sample during scanning Each sample was scanned using the SkyScan 1172 Micro-CT scanner (Bruker C T, Kontich, Belgium) at 3.99 μm resolution (voltage: 40 kV, current: 250 μA). The sample was positioned vertically (on end) in a plastic tube and rotated 180° during scanning along the axis of rotation of the sample. The resulting raw 2D projected scan images were subjected to the process of reconstruction using the SkyScan software to produce individual 2D greyscale slices along the axis of rotation spaced at the scanning resolution of 3.99 μm. An example of a resulting scan for a sample for Example 117 is shown in FIG. 19.

For each reconstructed dataset, a VOI (volume of interest) was created using the SkyScan software (CTAnalyzer) to include the volume of a complete foam structure (bubble) and exclude any air space around the exterior of the foam structure (bubble) and the sample backing material. This VOI was subjected to a 3D Analysis (built-in module) in CTAnalyzer to determine the total foam structure (dot) volume (total volume of the VOI) and the total polymeric matrix (solid material) volume as the object volume.

Total Foam Structure(Dot)Volume=Total Volume of VOI

Total Polymeric Matrix Volume=Object Volume within VOI

To determine the shell void volume of each sample structure (bubble), the reconstructed image stack was loaded into Avizo software (Thermo Fisher Scientific, Waltham, MA) and binarized. A

Compute Ambient Occlusion module was applied to the binarized dataset. The resulting dataset was a greyscale image stack of the structure's (bubble) shell void space, excluding the hollow core. The occlusion dataset was binarized a second time and a Label Analysis module was applied to the binarized occlusion dataset to measure the volumes of the structure's (bubble) shell voids. The sum of these volumes became the total shell void volume (excluding the hollow core).

Total Shell Void Volume=Sum of Void Volumes in Shell Only

To calculate the total shell volume, the total polymeric matrix volume and the total shell void volume were summed together. To determine the volume of the hollow core of the structure (bubble), the total shell volume was subtracted from the total foam structure (dot) volume

Total Shell Volume=Total Polymeric Matrix Volume+Total Shell Void Volume

Hollow Core Volume=Total Foam Structure(Dot)Volume−Total Shell Volume

The shell porosity of the structure (bubble) was taken as the percent of the ratio of the total shell void volume over the total shell volume. The foam structure (dot) porosity of the bubble (including the hollow core) was taken as the percent of the ratio of the sum of the total shell void volume and the hollow core volume over the total foam structure (dot) volume.

$$Shell Porosity ( \% ) = ( \frac{Total Shell Void Volume}{Total Shell Volume} ) \times 100$$

$$Foam Structure ( Dot ) Porosity ( \% ) = ( \frac{\begin{matrix}Total Shell Void Volume + \\ Hollow Core Volume\end{matrix}}{\begin{matrix}Total Foam Structure \\ ( Dot ) Volume\end{matrix}} ) \times 100$$

Water Solubility: Samples were subjected to water dissolution tests to quantify the percentage of recoverable content. The samples were cut into two specimens each approximately 5.1-cm by 5.1-cm (2-in by 2-in) and the weight of each specimen was measured and recorded. Then, the specimens for each sample were placed in a lidded glass jar with 500 g of deionized (DI) water, and subjected to heat and agitation in a heated shaker water bath (Aqua Pro Linear Shaker Bath, available from Grant Instruments, Beaver Falls, PA, USA) operating at 55.5° C. (130° F.) and at 100 strokes/minute. The samples were monitored for up to 6 hours to record the amount of time elapsed when the printed features visually detached from the paper substrate. After the heated soak, the glass jars were removed from the shaker and the paper substrates were removed with a tweezer and allowed to air dry. The contents of the glass jars were drained and filtered through a stainless steel wire cloth having 0.5-mm (0.02-in) openings and 57% open area (McMaster-Carr, Elmhurst, IL, USA) to remove excess water, and then dried in a 70° C. oven for 30 minutes (min). Then the dried remaining contents were weighed, and the % recoverable content from water dissolution was calculated as:

$$\% recovered content = 1 - \frac{dry weight of content left in filter}{weight of original sample}$$

### Abrasion Resistance:

Tests were performed using a Model 5750 Linear Abraser (Taber Industries, North Tonawanda, NY, USA) in accordance with ASTM D4060 Standard Test Method for Abrasion Resistance of Organic Coatings by the Taber Abraser using a flat, smooth stainless-steel attachment. The instrument had a free-floating horizontal arm that moved back and forth in a linear motion, and a vertical spline shaft was attached to the horizontal arm to allow weight to be added to the shaft. For each experiment, the samples were cut into approximately 5.08-cm by 20.32-cm (2-in by 8-in) strips. Each test specimen was affixed to a mounting plate at the bottom of the spline shaft so that a 3-cm by 3-cm by 3-cm stainless steel attachment was touching the side of the sample containing the patterned foam elements. The mounting plate was set such that the stainless-steel attachment contacted the patterned foam element at a 5° angle. Tests were performed where the shaft was mounted with 1 weight disc, corresponding to subjecting the specimen to 600 g of total weight exerted from the top. Each specimen is subjected to 60 cycles of abrasion, at a speed of 1 cycle/second to horizontal abraser arm movement. A fresh sample was used for each abrasion experiment, and the weight of the sample, as well as the weight of an uncoated piece of paper substrate, were measured before and after the abrasion experiment to calculate % loss as follows:

$$\% loss due to foam shredding = \frac{\begin{matrix}weight after abrasion - \\ weight before abrasion\end{matrix}}{\begin{matrix}weight before abrasion - \\ weight base paper\end{matrix}}$$

Precision of the test was determined by the guidance of ASTM D4060 and standard deviation of the specimens tested.

### Cushioning Characteristics:

Foam cushioning properties were evaluated using procedures outlined in ASTM D1696-14, “Dynamic Shock Cushioning Characteristics”, except where noted within this procedure. Test specimens 8 in×8 in (64 in²) were cut from sheets of substrate coated with foam. The Lansmont cushion curve tester consists of drop frame a platen with a series of weights, a speed meter, accelerometers, a DAC (digital analog converter), and a computer with TP3 (Test Partner version3) software. It is designed to measure the deceleration of a known mass hitting a cushioning material at a known speed. The drop weight used for this testing was 6.2 lbs for a psi of 0.096 lbs/in². The drop height used was 6 inches and the impact speed for each drop was measure. An exception to the ASTM test method was that the initial height of the foam, and the height of the foam after testing was recorded using a hand caliper along the edges of the foam sheet. The average g force deceleration of three samples is reported for drop #1 and drop #5. The percent change in g force deceleration was calculated by dividing the g force of the 5^{th} drop by the g force of the 1^{st} drop. The percent change was reported. Also, the initial foam height was reported as well as the foam height after the 5^{th} drop. The percent decrease in the foam height was calculated by dividing the height of the foam after the 5^{th} drop by the initial height and reporting it as the percent change.

### Seam Strength:

The seam strength of sealed foam-padded mailing envelopes was determined using the procedures outlined in ASTM F88/F88M, “Standard Test Method for Seal Strength of Flexible Barrier Materials.” Test specimens 2.5-cm (1-in) wide were cut from sealed mailing envelopes perpendicular to the seam, with at a length of at least 5.1 cm (2 in) of material on either side of the seam. Samples were conditioned overnight in a controlled temperature and humidity room at 22.8±1.1° C. (73.1±2° F.) and 50±2% relative humidity prior to testing. Specimens were loaded into a constant-rate-of-extension tensile tester (MTS ALLIANCE RT/50 TESTING MACHINE, Eden Prairie, MN, USA) with a 1000 N load cell at an initial jaw separation of 3.8 cm (1.5 in). The sample was pulled until seam separation using an extension rate of 25 cm/min (10 in/min), and the average peak load, average load, and total energy of six specimens per sample were recorded. The seam width was measured, and the seam strength was calculated as the peak load divided by the seam width. The peak force was reported as lbs/in, the average force is reported as lbs/in, the total energy is reported as lbf-in.

### Coefficient of Friction Test:

The static and dynamic coefficient of friction of the discrete foamed bubbles coated on paper was determined using the procedures outlined in ASTM D1894-14 “Standard Test Method for Static and Kinetic Coefficients of Friction of Plastic Film and Sheeting”. The test setup followed setup C (moving sled-fixed plane) as described in ASTM 1894-14 using an Instron coefficient of friction test apparatus part #2810-005 (available from Instron, Norwood MA, USA) and were tested on an Instron Universal Testing Load Frame 5564 (available from Instron, Norwood MA, USA) using a 100N load cell. Specimens were tested against steel planes with either a mirror or matte finish. The steel planes were wiped with 70/30 Isopropyl alcohol/water prior to testing. Samples were conditioned overnight in a controlled temperature and humidity room at 22.8±1.1° C. (73.1±2° F.) and 50±2% relative humidity prior to testing. Test specimens were cut to size and adhered to the movable sled as outlined in the ASTM. The sled weight was 200 g+/−5 g with the attached specimen. A cross-head speed of 6″/min was used to test the specimen. Samples were tested in triplicate. The kinetic and static coefficients of friction values were recorded and the average value was reported.

### Sample Preparation Procedures

TABLE 2
Different Polymer Chemistries from Water Based Coatings

| | RM | | RM | | RM | | RM | | RM | | % | Viscosity | | |
|---|---|---|---|---|---|---|---|---|---|---|---|---|---|---|
| Solution | (mass g) | | (mass g) | | (mass g) | | (mass g) | | (mass g) | | solids | (cP) | spindle | RPM |
| 51 | 1 | (500) | 11 | (32.9) | | | 21 | (7.5) | 31 | (1500) | 26.3 | 1552 | 3 | 30 |
| 52 | 2 | (333) | 11 | (21.5) | | | 21 | (3.4) | 31 | (1204.4) | 22.9 | 2556 | 3 | 30 |
| 53 | 3 | (1500) | 11 | (53.4) | | | 21 | (8.8) | | | 55.6 | 14560 | 3 | 3 |
| 54 | 4 | (1607) | 11 | (51.1) | 22 | (9.8) | 21 | (6.6) | | | 37.8 | 1800 | 3 | 30 |
| 55 | 5 | (225) | 11 | (16.4) | | | 21 | (5) | 31 | (1275) | 16.0 | 5316 | 3 | 10 |
| 56 | 6 | (505) | 11 | (25) | 22 | (9.9) | 21 | (5) | 31 | (1000) | 26.8 | 1756 | 3 | 30 |
| 57 | 1 | (442.5) | 11 | (58.7) | 3 | (811.1) | 21 | (8.2) | 31 | (1327.5) | 35.7 | 1788 | 3 | 30 |
| 58 | 7 | (500) | 11 | (40) | 21 | (25) | 31 | (750) | 32 | (750) | 42.2 | — | — | — |
| 1 (442.5) | 11 | (58.7) | 3 | (811.1) | 21 | (8.2) | 31 | (1327.5) | 23 | (5.8) | | | | |
| 1 (442.5) | 11 | (58.7) | 3 | (811.1) | 21 | (8.2) | 31 | (1327.5) | 23 | (11.6) | | | | |
| 1 (442.5) | 11 | (58.7) | 3 | (811.1) | 21 | (8.2) | 31 | (1327.5) | 23 | (265.5) | | | | |
| 1 (442.5) | 11 | (58.7) | 3 | (811.1) | 21 | (8.2) | 31 | (1327.5) | 24 | (12.4) | | | | |

TABLE 3
Formulations with Different Microsphere Types

| | RM | | RM | RM | RM | RM | | % | Viscosity | | |
|---|---|---|---|---|---|---|---|---|---|---|---|
| Solution | (mass g) | | (mass g) | (mass g) | (mass g) | (mass g) | | solids | (cP) | spindle | RPM |
| 61 | 1 | (436.25) | 12 (56.2) | 3 (803.5) | 21 (7.8) | 31 | (1309.5) | 35.6 | 2252 | 3 | 30 |
| 62 | 1 | (449) | 13 (55.9) | 3 (818.8) | 21 (7.9) | 31 | (1347) | 35.5 | 1480 | 3 | 30 |
| 63 | 1 | (453.75) | 14 (56.8) | 3 (803.4) | 21 (7.8) | 31 | (1361.25) | 35.4 | 1620 | 3 | 30 |
| 64 | 1 | (480) | 15 (56.1) | 3 (806.1) | 21 (11.4) | 31 | (1439.5) | 35.0 | 1864 | 3 | 30 |

TABLE 4
Formulations with Different Microsphere Loadings

| | RM | | RM | | RM | RM | RM | | % | Viscosity | | |
|---|---|---|---|---|---|---|---|---|---|---|---|---|
| Solution | (mass g) | | (mass g) | | (mass g) | (mass g) | (mass g) | | solids | (cP) | spindle | RPM |
| 71 | 1 | (437) | 11 | (12.3) | 3 (802.7) | 21 (7.8) | 31 | (1311) | 34.5 | 1812 | 3 | 30 |
| 72 | 1 | (444.25) | 11 | (28.8) | 3 (807.6) | 21 (7.9) | 31 | (1332.75) | 34.9 | 1608 | 3 | 30 |
| 73 | 1 | (448.5) | 11 | (90.1) | 3 (806.4) | 21 (8.0) | 31 | (1345.5) | 36.3 | 2012 | 3 | 30 |
| 74 | 1 | (449) | 11 | (119.5) | 3 (804.2) | 21 (8.2) | 31 | (1347) | 36.9 | 2092 | 3 | 30 |
| 75 | 1 | (439.5) | 12 | (10.6) | 3 (801.7) | 21 (8.1) | 31 | (1318.5) | 34.4 | 1976 | 3 | 30 |
| 76 | 1 | (442.9) | 12 | (27.1) | 3 (849.9) | 21 (7.9) | 31 | (1328.7) | 35.1 | 2020 | 3 | 30 |
| 77 | 1 | (432.5) | 12 | (90.8) | 3 (802.8) | 21 (8.2) | 31 | (1297.5) | 36.5 | 2212 | 3 | 30 |
| 78 | 1 | (436) | 12 | (118.7) | 3 (811.8) | 21 (8.5) | 31 | (1308) | 37.2 | 2160 | 3 | 30 |

### Preparation of Foamable Compositions

Formulations of the foamable compositions are summarized in Tables 2, 3, and 4 above. Generally, the raw materials are liquids, pellets, or powders. For solutions where the polymeric resin (RMs 3 & 4) is a liquid, the final solution can be prepared in a single step and an example solution procedure is shown below as Formulation 54. For solutions where the polymeric resins (RMs 1,2,5,6, & 7) arrived as solids, the polymeric resins were dissolved in water and/or IPA before preparing the final solution. The concentration of the polymer solution made was determined in Tables 2,3, and 4 by the amounts provided of the polymeric resin (RMs 1,2,5,6, & 7) and the amount of water (RM 31) or organic solvent (RM 32) added in the formulation. The preparation of Formulation 57 is provided below as a general representation of all mixtures where the polymeric resin arrived as a solid.

Formulation 54 procedure: 1.6 kg of Joncryl HPB 4030 (RM 4) was added to a 1 gallon jar. 51.1 g of Expancel 043DU80 (RM 11), 9.8 g of Methocel K4M (RM 22), and 6.6 g of colorant 32N711 (RM 22) were added to the 1-gallon jar. The solution was mixed for 30 minutes using mechanical stirring cowl blade. The solution was allowed to sit for at least 24 hours before using.

Formulation 57 procedure: One kilogram (1 kg) of G polymer (RM 1) was dissolved in 3 kg of deionized water under mechanical stirring to prepare an aqueous dispersion having 25 wt % solids. 1.77 kg of the G polymer solution at 25% solids was added to a 1-gallon jar. 0.443 kg of Dur-O-Set E130 (RM 3), 58.7 g of Expancel 043DU80 (RM11), and 8.2 g of colorant 32N711 were subsequently added. The solution was mixed for 30 minutes using mechanical stirring cowl blade.

Rotogravure Printing of the Foamable Composition—Hollow Bubbles

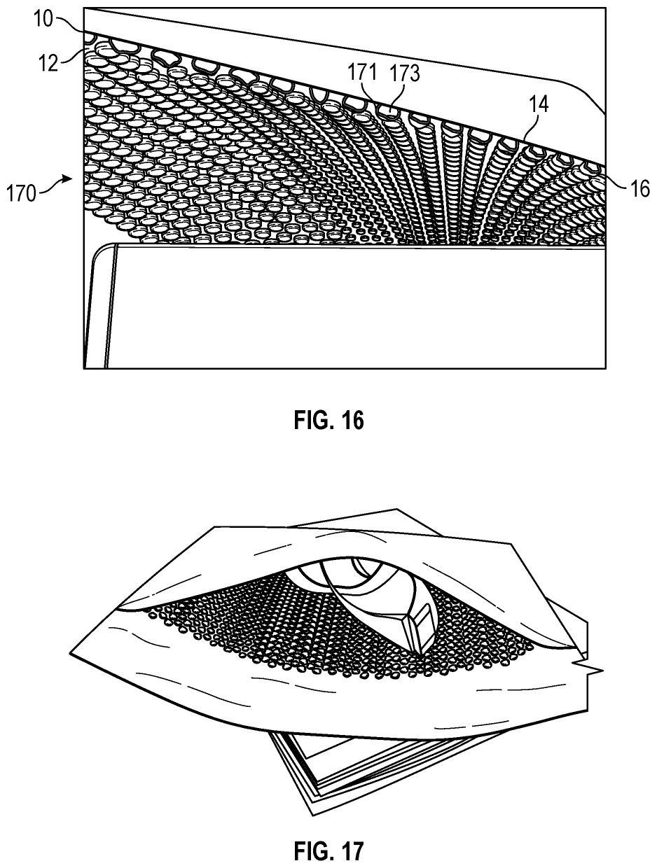

The following Examples illustrate rotogravure printing of the foamable composition to form a plurality of foam bubbles having a foamed exterior shell and a hollow interior filled with air as best seen in FIGS. 16, 18, and 19. Tables 15 and 16 list the tested rotogravure roll patterns and additional materials used in the foamable composition. Tables 17-22 show the foamable composition wet weights and dry weights for the various Examples.

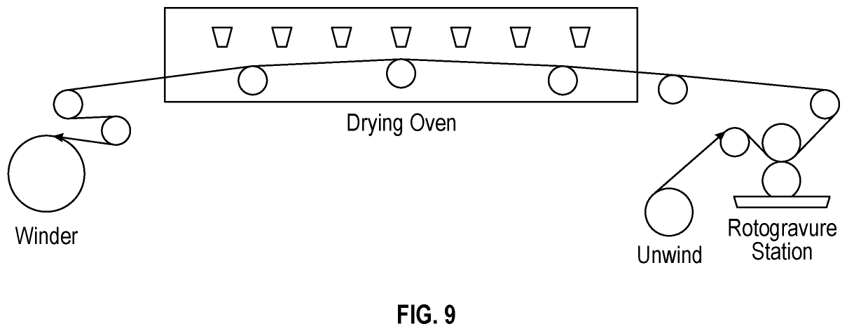

The rotogravure coating process as depicted in FIG. 9 deposited the foamable composition onto the substrate in an array of liquid dots. In some embodiments, a substantially continuous coating was also used and applied to the substrate first or at the same time with the array of liquid dots. See the rotogravure roll depicted in FIG. 11 for example of dual coating in a single pass. In one embodiment, a 55 lb (88.3 gsm) kraft paper substrate was used. The diameter and height of the dots changed as a function of the coating process parameters and the specific rotogravure pattern utilized, including the individual cell volume within the pattern. In one embodiment, the rotogravure cells forming the array of liquid dots were approximately one-half of a 4 mm diameter sphere, which means the cell depth was 1.5 mm, or approximately one half of 1 mm sphere, which means the cell depth was 0.5 mm. In certain embodiments, the depth aspect ratio of the cell diameter to the cell depth was from 1 to 10, or 1 to 5, or 1 to 3. For example, patterned roll F had a cell depth of 1.5 mm and cell diameter of 8 mm, and patterned roll H had a cell depth of 1.5 mm and cell diameter of 12 mm. The aspect ratio of the cell diameter to depth controlled the diameter, height, and basis weight of a deposited dot. The depth aspect ratio of roll H was 8, and the depth aspect ratio of roll F was 5.33 and the aspect ratio of roll D was 2.67.

In various embodiments, the cell volume can be from 0.2 to 500 mm³ or from 0.2 to 250 mm³ or preferably from 0.2 to 100 mm³, or from 1 to 20 mm³. The cell volume is quite large compared to typical rotogravure printing since the foam structures tend to be large for the desired cushioning.

The rotogravure process depicted in FIG. 9 illustrates a method of making a packing material. In includes, unwinding a roll of sheet material, passing the sheet material through a rotogravure station and printing a foamable composition to a first major surface of the sheet material forming a coated sheet material using a rotogravure roll, passing the coated sheet material through a drying oven and foaming the foamable composition into a plurality of foam structures each having a hollow core and a foam exterior shell. After drying, the packaging material can be wound into a roll by a winder.

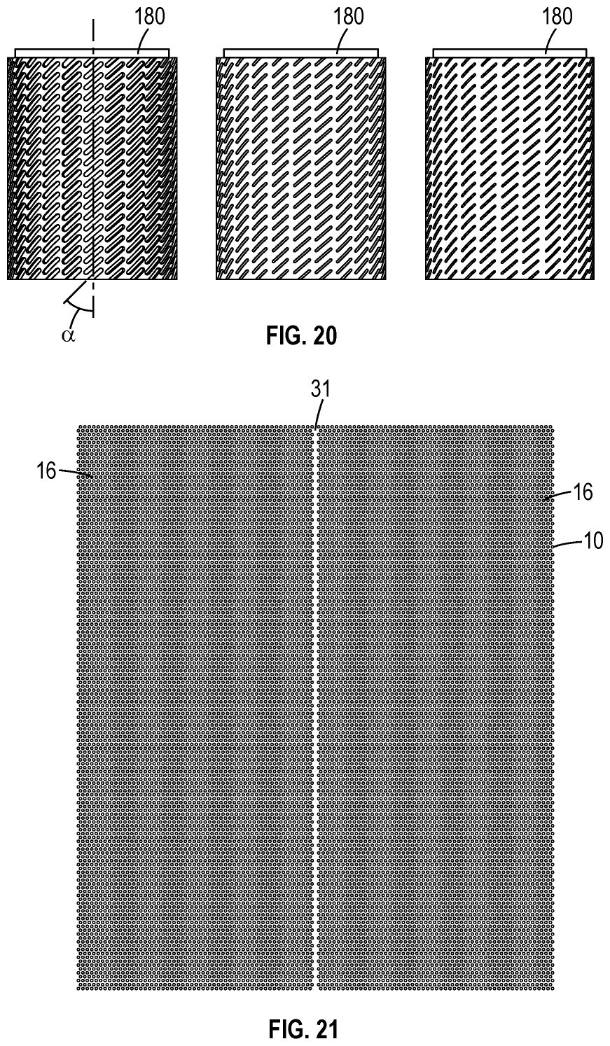

Suitable rotogravure rolls or sleeves 180 are depicted in FIGS. 11, 13, and 20. Various patterns can be placed onto the outer circumference of the roll. In particular a pattern having diagonal rotogravure cells can be used as depicted in FIG. 20. Each cell has a length and a width when viewed in a top-down view. The length can be significantly longer than the width resulting in a plan view aspect ratio of 10:1 to 1:1. The length of the cell is disposed at an angle α to the longitudinal axis 181 of the roll as seen. The angle α can be any angle from 0 to 180 degrees such as between 35 degrees to 55 degrees and in one embodiment was 45 degrees.

The deposited liquid dot was dried in an oven and foamed during the drying process creating foam bubbles comprising an outer shell of a foam material and a hollow center or hollow core filled with air. The exterior shell also attaches the foam bubbles to the sheet material—meaning the structure has a sheet material layer, followed by a foamable composition layer located between the sheet material and the hollow center that is continuous with and also forms the exposed exterior shell, followed by a hollow center portion and lastly followed by the exterior foam layer of the shell as best seen in the cross sections of FIGS. 18 and 19.

It is believed that while drying, the foamable composition, the outer surface skins over in the oven, and the remaining water in the composition, is at least partially vaporized into the center of the dot structure and exited through the substrate creating the final hollow core structure seen in FIGS. 18 and 19. In particular, it was found that slowing down the web speed through the oven after the rotogravure printing process on the substrate was necessary to the formation of the skin layer and maximum hollow core volume within the foam bubble.

The hollow foam bubble structure has the advantage of creating a larger overall structure for a given amount of the foamable composition deposited than can be obtained with non-hollow core foam structures or solid core foam structures where the foam layer extends completely through the structure attached to the sheet material. Since they have an air-filled center, the final dried foam material is concentrated and utilized only in the outer shell of the structure. The resulting overall substrate coated with the foam is quite like a recyclable version of plastic (polyethylene) bubble wrap. It has a pleasing tactical sensation and good cushioning properties resulting from the hollow air-filled core of the foam bubbles just like plastic bubble wrap.

The formulation of Example 51 was used to prepare the padded foamed sheet of Example 101. The Kraft paper substrate roll was placed on the unwind shown in FIG. 10. The paper was fed into the rotogravure station and the drive nip was closed. An electric motor was used to adjust the web speed of the paper substrate to approximately 2.4 meters per minute (m/min; 8 ft/min) as it was fed into the rotogravure station. The coated paper was passed through the oven set at 350° F. (182° C.) and the oven residence time was 60 seconds. Hot air was passed through a manifold through eight nozzles of width 15.5 inches by 0.375 inches onto the printed web. The nozzle tip to paper distance was 2.5 to 3 inches. The speed of the air exiting the nozzles ranged from 4 m/s to 9 m/s as measured by a digital rotating vane anemometer (Omega HHF5000, 25 mm diameter probe) placed 1 inch from the nozzle outlet. A preferred air speed is 7 m/s at 350° F. with a residence time of 60 seconds in the length of the dryer. At an air speed of 15 m/s and a temperature of 500° F. a dwell time of 10 seconds can be used. The maximum temperature and time can be a function of the melting temperature of the polymers in composition.

The foamable composition was deposited onto a roll of 55-lb Kraft paper via rotogravure with a 3D printed gravure sleeve. The sleeve was printed by a Stratasys F370 FDM printer with ABS filament and layer height of 0.007 in. The printed sleeve of 7.62 cm inside diameter by 10.3 cm outside diameter by 35.5 cm long was mounted onto a 7.6 cm diameter shaft to form a gravure roll 180. The sleeve was printed to form hemispherical cells on the outer surface with dimensions 4 mm diameter by 1.5 mm deep with 2 mm spacing between adjacent cells. The shaft mounted sleeve was placed into the rotogravure station to print the foamable composition. The roll pattern is described in Table 5 as gravure pattern D.

An unexpected benefit of 3D printed gravure rolls was that the 3D printing process left the surface of the roll with circumferential ridges and valleys as seen in FIGS. 11 and 13. A machined gravure roll in metal would ordinarily be perfectly smooth in the land areas between the large circular holes that form the discrete elements. Thus, in addition to foamable composition printing of the discrete foamed elements, the surface of the substrate was also printed with closely spaced lines creating a continuous foamed coating layer on the substrate. The continuous foamed layer significantly increased the seam strength of the heat-sealed packaging articles, such as mailers and envelopes, and is believed to strengthen the durability of the discrete foamed elements by more firmly anchoring them to the substrate. The Examples created within disclosure utilized 3D printed rotogravure patterned rolls that were then lightly sanded to remove continuous printing in between foam bubbles.

The resulting foamed coating, using the gravure roll of FIG. 13, on the substrate is shown in FIGS. 12A and 12B. As seen in FIG. 12B, the printed lines from the 3D printed gravure roll show up as faint lines in the continuous coating layer between the discrete elements. The continuous coating layer ends near the edge of the substrate 10 leaving an uncoated area 19 and then only the surface of the kraft paper is present. The foamable composition in this embodiment was dyed to match the color of the kraft paper to be more visually appealing.

The basis weight range of the continuous foamed coating can be from 0-50 gsm, from 5-30 gsm, or from 5-20 gsm. The basis weight range of the discontinuous discrete foamed elements can be from 5-100 gsm, from 10-80 gsm, or from 15-70 gsm. The total coating weight would be the addition of the previous individual ranges.

Referring now to FIG. 11, the concept of printing the foamable composition onto the substrate with a gravure roll having both discrete circular elements 185 and a plurality of micro groves 187 to form a continuous foam coating is shown. The discrete elements were formed by large circular apertures arranged intro a parallelogram pattern that places the discrete elements into rows of angled lines with respect to the edge of the substrate. The continuous coating layer was laid down by circumferential grooves in the roll's land areas between the apertures. This was achieved by 3D printing closely spaced circumferential lines or filaments onto the rolls surface. Since the composition foamed after application, laying down the foamable composition into discrete lines formed a substantially continuous coating on the substrate once the composition foamed. Rather than 3D print the gravure roll, a machined roll having similar features could also be constructed.

The gravure roll coating approach enabled a continuous foamed coating between the discrete foamed elements. This continuous coating provided a continuous heat sealable layer across the entire surface. This continuous coating substantially increased seam seal strength when heat sealed. The foam coated substrate with a continuous foam layer and discrete foamed elements can be formed into any of the packaging articles depicted in FIG. 2, 3, 4, 5, 6, or 7 and the preceding discussion of how to make them. It is particularly suited to forming an envelope having heat-sealed seams and a sealing flap such as the envelope with three heat-sealed seams forming an internal pouch and closure the sealing flap depicted in FIGS. 11A-11C. These packages are often called mailers and are used to ship products from online retailers to customers.

A dye or a pigment can be added to foamable compositions in order to match the foam's color to that of the kraft paper onto which it was being coated. The colored coating created a good color match between the discrete elements, the continuous coating layer and the kraft paper resulting in a visually appealing article. In some embodiments, the concentration of the dye ranged from 0.01 wt-% to 5.0 wt-%.

TABLE 5
Spherical Shaped Patterned Roll Design

| | | Cell | | Cell Edge | % | |
|---|---|---|---|---|---|---|
| | | Diam- | Cell | to Edge | Pattern | Cell |
| | | eter | Depth | Spacing | Cover- | volume |
| Roll | Cell Shape | (mm) | (mm) | (mm) | age | (mm³) |
| B | hemispherical | 1 | 0.5 | 2 | 10.1 | 0.3 |
| C | hemispherical | 2 | 1.0 | 6 | 3.6 | 2.1 |
| D | hemispherical | 4 | 1.5 | 2 | 14.5 | 10.6 |
| F | hemispherical | 8 | 1.5 | 2 | 17.9 | 24.7 |
| H | hemispherical | 12 | 1.5 | 2 | 19.3 | 38.9 |

TABLE 6
Rectangular Shaped Patterned Roll Design

| | | | | | DW Edge | CW Edge | | |
|---|---|---|---|---|---|---|---|---|
| | | Cell | Cell | Cell | to Edge | to Edge | % | Cell |
| | | Width | Length | Depth | Distance | Distance | Pattern | Volume |
| Roll | Cell Shape | (CW) | (DW) | (mm) | (mm) | (mm) | Coverage | (mm\hat{ }3) |
| I | Rectangular | 2 | 14 | 1.5 | 5 | 2 | 50.9 | 40.7 |
| J | Rectangular | 4 | 16 | 1.5 | 3 | 2 | 75.7 | 90.9 |
| K | Rectangular | 14 | 2 | 1.5 | 2 | 2 | 59.9 | 40.7 |
| L | Rectangular | 16 | 4 | 1.5 | 4 | 2 | 61.2 | 90.9 |
| M | Rectangular | 1 | 13 | 1.5 | 3 | 5 | 7.9 | 19.2 |
| N | Rectangular | 2 | 14 | 1.5 | 1 | 3 | 30.2 | 40.7 |
| 0 | Rectangular | 4 | 16 | 1.5 | 0 | 8 | 33.3 | 90.9 |

TABLE 7
Hollow Core with Porous Shell Foam Process Variables

| | | | | Line | Oven | Residence |
|---|---|---|---|---|---|---|
| Exam- | Formu- | Sub- | Patterned | Speed | Temp | Time |
| ple | lation | strate | Roll | (ft/min) | (° F.) | (sec) |
| 101 | 51 | 41 | D | 8 | 350 | 60 |
| 102 | 52 | 41 | D | 8 | 350 | 60 |
| 103 | 53 | 41 | D | 8 | 350 | 60 |
| 104 | 54 | 41 | D | 8 | 350 | 60 |
| 105 | 55 | 41 | D | 8 | 350 | 60 |
| 106 | 56 | 41 | D | 8 | 350 | 60 |
| 107 | 57 | 41 | D | 8 | 350 | 60 |
| 108 | 61 | 41 | D | 8 | 350 | 60 |
| 109 | 62 | 41 | D | 8 | 350 | 60 |
| 110 | 63 | 41 | D | 8 | 350 | 60 |
| 111 | 64 | 41 | D | 8 | 350 | 60 |
| 112 | 71 | 41 | D | 8 | 350 | 60 |
| 113 | 72 | 41 | D | 8 | 350 | 60 |
| 114 | 73 | 41 | D | 8 | 350 | 60 |
| 115 | 74 | 41 | D | 8 | 350 | 60 |
| 116 | 75 | 41 | D | 8 | 350 | 60 |
| 117 | 76 | 41 | D | 8 | 350 | 60 |
| 118 | 77 | 41 | D | 8 | 350 | 60 |
| 119 | 78 | 41 | D | 8 | 350 | 60 |
| 120 | 51 | 41 | B | 8 | 350 | 60 |
| 121 | 51 | 41 | H | 8 | 350 | 60 |
| 122 | 51 | 41 | C | 8 | 350 | 60 |
| 123 | 51 | 41 | F | 8 | 350 | 60 |
| 124 | 63 | 41 | F | 8 | 350 | 60 |
| 125 | 64 | 41 | F | 8 | 350 | 60 |
| 126 | 51 | 41 | F | 8 | 350 | 60 |
| 127 | 57 | 41 | K | 8 | 340 | 60 |
| 128 | 57 | 41 | J | 8 | 340 | 60 |
| 129 | 57 | 41 | L | 8 | 340 | 60 |
| 130 | 57 | 41 | O | 8 | 340 | 60 |
| 131 | 57 | 41 | N | 8 | 340 | 60 |
| 132 | 57 | 41 | I | 8 | 340 | 60 |
| 133 | 57 | 41 | M | 8 | 340 | 60 |
| 134 | 58 | 41 | D | 8 | 340 | 60 |
| 135 | 59 | 41 | D | 8 | 340 | 60 |
| 136 | 60 | 41 | D | 8 | 340 | 60 |
| 137 | 61 | 41 | D | 8 | 340 | 60 |
| 138 | 62 | 41 | D | 8 | 340 | 60 |

### RESULTS

Coating weight and overall sample thickness of foam-padded materials is provided in Table 8. To calculate coating weight, the basis weight of the Kraft paper was assumed to be 88.3 gsm. The total thickness of the foam and paper was measured using simple calipers, and the thickness of the uncoated Kraft paper was 0.14 mm (5.5 mil). Numerous solution cast polymer systems were evaluated. Surprisingly, it was determined that the hollow core porous shell structure could be made with multiple chemistries coated out of solution with the proper solution viscosity with the preferred viscosity being between 1000 cP to 15,000 cP. Significantly below this viscosity range, 500 cP or lower discrete dots of solution were not properly deposited and instead a continuous coating without dots of solution was obtained. Higher viscosity solutions created challenges for solution handling during coating, but dots were able to be transferred.

Examples shown in Table 8 where the hollow core percent of the total bubble volume such as Examples 106 (11%), Example 117 (35%), and Example 120 (30%) surprisingly had total porosities greater than 50% as shown by X-ray tomography. This was surprising as it was expected that the total porosity be determined mainly by the volume of the hollow core. The results show that the total porosity was determined by the volume of the hollow core, porosity of the shell, and the shell thickness.

TABLE 8
Foam Characterization

| | | Coating | | | | Est. | Est. | Estimated |
|---|---|---|---|---|---|---|---|---|
| | Basis | Basis | Dot | Dot | Shell | Bubble | Core | % |
| | Wt. | W. | Dia. | Height | Thickness | Volume | Volume | Hollow |
| Example | (gsm) | (gsm) | (mm) | (mm) | (mm) | (mm³) | (mm³) | Core |
| 101 | 122.2 | 33.9 | 4.1 | 1.9 | 0.15 | 25.1 | 21.5 | 86% |
| 102 | 110.9 | 22.6 | 3.5 | 1.6 | 0.21 | 15.4 | 11.9 | 77% |
| 103 | 167.9 | 79.6 | 5.4 | 2.2 | 0.44 | 50.4 | 35.3 | 70% |
| 104 | 130.8 | 42.5 | 5.1 | 2.5 | 0.44 | 51.1 | 35.0 | 68% |
| 105 | 104.5 | 16.2 | 3.7 | 0.69 | *no shell | 7.4 | | 0% |
| 106 | 117.5 | 29.2 | 2.8 | 1.2 | 0.94 | 7.4 | 0.8 | 11% |
| 107 | 129.9 | 41.6 | 5.2 | 3 | 0.21 | 63.7 | 53.8 | 84% |
| 108 | 133 | 44.7 | 3.9 | 1.8 | 0.54 | 21.5 | 11.2 | 52% |
| 109 | 128.4 | 40.1 | 3.3 | 2.1 | 0.12 | 18.0 | 15.4 | 86% |
| 110 | 135.6 | 47.3 | 2.5 | 1.9 | 0.12 | 9.3 | 7.6 | 82% |
| 111 | 135.9 | 47.6 | 2.9 | 1.6 | 0.044 | 10.6 | 9.9 | 94% |
| 112 | 134.2 | 45.9 | 3 | 2.3 | 0.2 | 16.3 | 12.2 | 75% |
| 113 | 132.9 | 44.6 | 4.4 | 2.2 | 0.17 | 33.5 | 28.5 | 85% |
| 114 | 134.9 | 46.6 | 4.6 | 2.7 | 0.18 | 44.9 | 38.1 | 85% |
| 115 | 137.6 | 49.3 | 5.2 | 3.8 | 0.21 | 80.7 | 68.2 | 84% |
| 116 | 133.1 | 44.8 | 2.9 | 1.3 | 0.12 | 8.6 | 7.2 | 84% |
| 117 | 126.2 | 37.9 | 3.5 | 1.1 | 0.71 | 10.6 | 3.7 | 35% |
| 118 | 134.3 | 46 | 3.2 | 1.8 | 0.49 | 14.5 | 7.0 | 48% |
| 119 | 146.6 | 58.3 | 5 | 2.6 | *no shell | 51.1 | | 0% |
| 120 | 96.2 | 7.9 | 1.1 | 0.61 | 0.25 | 0.58 | 0.2 | 30% |
| 121 | 117.9 | 29.6 | 6.6 | 2.6 | 0.3 | 89.0 | 73.5 | 83% |
| 122 | 118.5 | 30.2 | 2.4 | 1.4 | 0.08 | 6.3 | 5.5 | 87% |
| 123 | 137.3 | 49 | 6.5 | 3.5 | 0.19 | 116.1 | 103.0 | 89% |
| 124 | 143.7 | 55.4 | 2.5 | 1.9 | 0.12 | 9.82 | 7.62 | 82% |
| 125 | 146.5 | 58.2 | 2.9 | 1.6 | 0.044 | 10.36 | 9.94 | 94% |
| 126 | 128.4 | 40.1 | 4.1 | 1.9 | 0.15 | 25.0 | 24.7 | 99% |
| 134 | 121.4 | 32.3 | 5.2 | 1.9 | 0.11 | 21.0 | 17.7 | 84% |
| 135 | | | | | | | | |
| 136 | | | | | | | | |
| 137 | | 41.4 | 4.0 | 2.0 | 0.15 | 25.1 | 21.6 | 86% |
| 138 | | 33.6 | | | | | | |

Table 8 shows the optical microscopy characterization of samples 101-126. The Examples disclosed in Table 8 were spherical shaped bubbles. The characterization data includes bubble diameter, bubble height, bubble volume, hollow core volume, and percent hollow core volume of the total bubble volume. Table 8 shows that the volume of the hollow core ranged from 0.2 mm³ to over 100 mm³, while the percent of the hollow core volume of total bubble volume ranged from 11 to 99%. The shell thickness ranged from 0.044 mm to 0.94 mm. The basis weight of these samples ranged from 7.9 up to 79.6 gsm. The basis weight was influenced by the size and density of the dots deposited on to the substrate. Also, the solution % solids affected the basis weight of the foam materials.

Table 9 shows the characterization of Examples 127-133 which are rectangular in shape, thus the length, width, height, and shell thickness were measured to calculate the bubble volume, the hollow core volume, and the percent hollow core volume. The basis weight of the rectangularly shaped foam bubble coating that deposited onto a substrate ranged from 109 gsm to 148 gsm. This was increased or decreased outside of these values simply by increasing or decreasing the size of the bubble, the amount of material deposited into given area by changing the cell depth of the rotogravure pattern, or by changing the density of the foam pattern for a given area. The height of the foam dots ranged from 1.4 to 3.0 mm. The bubble volume after foaming ranged from 39 to 211 mm³, and the hollow core volume ranged from 21 to 175 mm³. The percent of the bubble formed which was the hollow core made up 53% to 87% of the total bubble volume. The shell thickness ranged from 0.12 mm to 0.32 mm.

TABLE 9
Characterization of Rectangular Shape Foam Dots

| | | | | | | | Estimated | Estimated | Estimated |
|---|---|---|---|---|---|---|---|---|---|
| | Basis | Coating | | | | Shell | Bubble | Core | % |
| | Wgt | Basis | Width | Length | Height | Thickness | Volume | Volume | hollow |
| Example | (gsm) | Wgt | (mm) | (mm) | (mm) | (mm) | (mm³) | (mm³) | core |
| 127 | 138 | 49.7 | 4.19 | 12.9 | 2.3 | 0.31 | 122 | 85 | 70% |
| 128 | 136.6 | 48.3 | 1.89 | 9.8 | 3.0 | 0.32 | 56 | 31 | 56% |
| 129 | 159.2 | 70.9 | 5.5 | 15.5 | 2.3 | 0.14 | 200 | 175 | 87% |
| 130 | 148.0 | 59.7 | 6.9 | 12.5 | 2.4 | 0.23 | 211 | 171 | 81% |
| 131 | 130.9 | 42.6 | 2.3 | 13.7 | 1.4 | 0.19 | 44 | 31 | 70% |
| 132 | 122.2 | 33.9 | 1.9 | 11.6 | 1.8 | 0.30 | 39 | 21 | 53% |
| 133 | 109.1 | 20.8 | 3.7 | 14.7 | 2.1 | 0.12 | 111 | 95 | 86% |

Table 10 shows X-ray tomography characterization of the foam bubbles. X-ray tomography is a method for generating 3-dimensional imaged volumes from 2-dimensional X-ray image slices. This allowed for the total porosity of the foam bubble to be accurately characterized. X-ray tomography enabled the accurate characterization of total bubble volume, and the volume of the hollow core same as with optical microscopy. In addition, x-ray tomography allowed for the porosity of the foam bubble shell to be characterized as well. The combination of all three allowed for the accurate characterization of the total foam dot porosity to be determined. X-ray tomography characterization shown in Table 10 discloses total bubble volumes that ranged from 0.7 mm³ to 125.7 mm³, hollow core volumes that ranged from 0.21 mm³ to 56.3 mm³, shell porosity that ranged from 71.5% to 82.4%, and total foam bubble porosity that ranged from 79.2% to 88.0%.

Surprisingly, changing the overall bubble volume of the foam bubbles did not dramatically affect the total porosity of the structure. Therefore, the bubble size ranged from very small, less than 1 mm³, to very large, over 125 mm³, while maintaining greater than 50% porosity.

TABLE 10
X-Ray Tomography Characterization
Hollow Core Porous Shell Porosity

| | Total Foam | Hollow Core | Shell | Foam Dot |
|---|---|---|---|---|
| | Dot Volume | Volume | Porosity | Porosity |
| Example | (mm³) | (mm³) | (%) | (%) |
| 117 | 7.89 | 3.90 | 71.5 | 85.6 |
| 118 | 14.65 | 4.35 | 75.6 | 82.8 |
| 119 | 27.82 | 7.63 | 82.4 | 87.2 |
| 106 | 6.51 | 0.88 | 76.0 | 79.2 |
| 120 | 0.71 | 0.21 | 80.1 | 86.1 |
| 121 | 125.71 | 56.31 | 78.2 | 88.0 |

Table 11 shows the comparison of the total bubble volume and the hollow core volume as well as the percentage of the total bubble volume that is the hollow core. The values between the two methods matched reasonably well. When shell porosity needs to be measured, X-ray tomography should be used. When only the hollow core volume and foam structure volume needs to be measured, one of skill in the art of measurement sciences can choose either method (optical microscopy or X-ray tomography) that gives a reasonable result. Regularly shaped foam structures such as circular or rectangular may lend themselves well to optical measurements whereas irregularly shaped structures may require X ray tomography.

The combination of the two methods showed that Examples where the % hollow core volume was low, such as in Example 106 where the hollow core volume made up only 10.8%-13.5%, depending on the method, the total porosity of the bubble was actually 79.2%. The porous shell had a large effect on the overall porosity of the foam dot. In various embodiment of the invention the shell porosity can be from 50% to 95%, or from 60% to 90%, or from 65% to 85%.

In theory and by the formulation ranges provided, samples where the hollow core made up only a small fraction of the total bubble volume, for example less than 10%, the total porosity of the bubble still exceeded 50% porosity. The porosity of the shell was controlled by the type and the loading of microspheres within the composition and the process conditions used to dry and expand the microspheres.

TABLE 11
Comparison of X-ray Tomography and Optical Microscopy
Foam Bubble Volume and Hollow Core Volume.

| | | | X-Ray | | | Optical |
|---|---|---|---|---|---|---|
| | | | Tomography | | | Microscopy |
| | X-Ray | X-Ray | % Hollow | Optical | Optical | % Hollow |
| | Tomography | Tomography | Core of | Microscopy | Microscopy | Core of total |
| | Total Foam | Hollow Core | Total Bubble | Total Foam | Hollow Core | Bubble Core |
| | Dot Volume | Volume | Core Volume | Dot Volume | Volume | Volume |
| Sample | (mm³) | (mm³) | (%) | (mm³) | (mm³) | (%) |
| 117 | 7.89 | 3.90 | 49.4 | 10.6 | 3.7 | 34.9 |
| 118 | 14.65 | 4.35 | 29.7 | 14.5 | 7.0 | 48.2 |
| 119 | 27.82 | 7.63 | 27.4 | 51.1 | — | |
| 106 | 6.51 | 0.88 | 13.5 | 7.4 | 0.8 | 10.8 |
| 120 | 0.71 | 0.21 | 29.5 | 0.58 | 0.2 | 34.4 |
| 121 | 125.71 | 56.31 | 44.8 | 89.0 | 73.5 | 82.5 |

Abrasion Resistance test results are summarized in Table 12 and were used to assess the durability of the foam coated samples. After abrasion, the samples suffered up to approximately 50% of mass loss due to the foam composition being shredded off after repeated abrasion. Thus the Abrasion Resistance for the packaging material can be less than 50%, 40%, 35%, 30%, 20%, or less than 10%.

TABLE 12
Taber Abrasion Test Results

| | Foam Shed, % mass loss from |
|---|---|
| Example | abraded area |
| 103 | 3.85% |
| 112 | 16.73% |
| 115 | 31.36% |
| 119 | 46.17% |
| 122 | 26.24% |
| 123 | 20.71% |

Table 13 discloses seam strength results of the sheet materials. Seam strength values were important for developing adequate strength of heat-sealed edges of packaging articles so as to avoid needing to use an adhesive layer to seal the seams. In this disclosure, the foam material acted as the cushioning layer as well as the heat sealable layer that created the packaging article edge. Generally, seam strengths with a peak force value of at least 1.0 lbs/in are considered acceptable and peak force values of at least 1.5 lbs/in, or at least 2.0 lbs/in, or at least 3.0 lbs/in are preferred. The sealing temperature and dwell times were varied to increase or decrease the seam strength values. The values reported were taken at 350° F. with a seal time of 0.8 seconds. It was found that increasing the temperature or dwell time increased the seam strength values. Seam strength values reported ranged from 0 lbs/in for example 105 where no heat seal was formed, to 4.5 lbs/in for example 125. The hollow bubble and porous shell structure as well as the polymeric resin also effected the resulting seam strength values. The total energy required to peal open the heat-sealed seam was also reported. These values ranged from 0 lbf-in for example 105 to 1.15 lbf-in for example 113.

The flexibility of this invention allowed for the hollow bubble porous shell chemistry, bubble shape, size, and aspect ratios to be easily modified to tailor to the required foam properties. For examples 101-107 the polymer chemistry of the base resin, which made up generally more than 85% of the total composition, changes. By changing the base chemistry of the polymeric resin, the peak seal strength and the total energy to peal apart the seam changed by a factor greater than 10×.

In certain embodiments, foam structures cast from solution that results in hollow cores and porous shells structures utilizing polymer chemistries had seam strengths with a peak force of at least 1.0 lbs/in, more preferably at least 1.5 lbs/in, most preferred at least 2.0 lbs/in. In other embodiments, foam structures cast from solution that result in hollow cores and porous shell structures utilizing polymer chemistries had seam strengths which required a total energy of at least 0.5 lbf-in, more preferably 0.75 lbf-in, and most preferably 1.0 lbf-in to peel open the seam.

The flexibility of this invention allowed for the optimization of porous shell by selection of the type and loading of expandable microspheres used to create the porous shell. Expandable microspheres come in an array of varieties where both the initial and final microsphere size can be chosen as well as the onset of expansion temperature being varied to suit specific processing conditions. These key microsphere properties affected the shell thickness and overall integrity of the shell, as well as the volume of the hollow core, if the onset of expansion temperature was close to the boiling point of the solvent. Examples 108-111 show this effect. By selecting the correct microsphere type for a given set of process conditions, in this case 60 seconds at 350F, the microspheres with a high activation temperature, such as shown in Example 111, resulted in a shell with smaller pores, reduced over porosity of the shell, better shell integrity, which corresponded to higher seam seal strength peak force.

In certain embodiments, the pores size contained within the foam shell ranged between 10-250 microns, more preferably ranged between 20-200 microns, more preferably the pore size was 40-180 microns, most preferably 60-160 after coating and drying of the foamed materials.

The % loading of microspheres of the dried foam composition also had a large effect on the ultimate strength of the heat-sealed seam. Examples 112-115 show this effect for EXPANCEL 043DU80 (RM 11), and examples 116-119 show this effect for DUALITE U010-130D (RM12). Both series show microsphere loadings that ranged from −1% to −12% of the total foam composition after drying. Surprisingly, the effect of microsphere loading on seam strength was not linear in nature. The data for examples 112-115 shows that the preferred range of microsphere loading was near 4% of the total composition after drying. Lower amounts of microsphere or higher amounts of microsphere decrease the peak force and total energy required to peal apart the seam. This was surprising in the fact that one skilled in the art would tend to believe that simply increasing microsphere content would dilute the polymeric resin volume which is what ultimately creates the heat seal. Therefore, one would have expected the lowest microsphere loading to have the highest seam strength, as is shown for Examples 116-119. This factor was taken into account when balancing all the other properties required for a suitable packaging article.

In certain embodiments, the preferred microsphere loading was between 1-12 wt-% of the total composition, preferably the microsphere loading was up to 8 wt-% of the total dried composition, most preferably the microsphere composition was between 0.1-5 wt-% of the total dried composition.

The pattern selected to coat the foam onto a substrate also had large effects on the seam strength. This was observed in numerous Examples provided in Table 13; however, a few were highlighted. Comparing Examples 110 & 111 to 124 & 125 shows that by increasing the bubble size and decreasing space in between the dots provided superior seam strength. The effects were also seen in the dot diameter of resulting foam structures in Table 8, for a given system, wider dots encouraged higher seam strengths. The amount of overlap between foam dots on opposing surfaces during heat sealing allowed the best opportunity for ideal heat sealing. Additionally, the pattern selected effected the height of the bubble, and when compared to identical systems where the foam bubble diameter was the same and the only difference was the height, as in Example 121 (Formulation 51 coated with patterned roll H) compared to Example 123 (Formulation 51 with patterned roll F) the measured dot diameters were nearly identical 6.5 mm+/−0.1 mm, however the dot heights were substantially different. Example 121 had a bubble height of 2.6 mm, and example 123 had a height of 3.5 mm. Surprisingly, Example 123 had a seam strength nearly 50% higher than that of Example 121.

In certain embodiments, the foam bubbles have a diameter that ranged from 1 mm to 7 mm, or 1 mm to 3 mm, or more preferred 3 mm to 7 mm. In other embodiments, the bubble height ranged from 0.6 mm to 3.8 mm, or is at least 0.6 mm, or at least 2 mm, more preferably was in the range of 1.5 mm to 4 mm.

The Examples show this is a complicated system of polymer chemistry, formulation parameters that include % solids, raw material type and loading, pattern coated, and process conditions which effect the degree of foaming and ultimately the size of the of the hollow core and degree porosity in the shell. All of these variables have interactions that affect the foam material properties and the requirement for a given application may prioritize one property over another. Additionally, the seam strength values are for a given set of sealing conditions. Increasing temperature, dwell time, or pressure can significantly increase seam strength values. Lastly, substrate selection can improve seam strength if the substrate compatibility with the foam resin increases. By improving substrate polymer compatibility either through additives embedded or coated on the paper, or by choosing a film or nonwoven that is more compatible with the foam composition selected heat seal strength can be improved further.

TABLE 13
Seam Strength Test Results

| | Peak Force | Average Force | Total Energy |
|---|---|---|---|
| Example | (lbs/in) | (lbs/in) | (lbf-in) |
| 101 | 2.2 | 1.7 | 0.63 |
| 102 | 1.3 | 0.7 | 0.28 |
| 103 | 2.2 | 1.6 | 1.06 |
| 104 | 0.6 | 0.3 | 0.13 |
| 105 | 0 | 0 | 0 |
| 106 | 0.2 | 0.1 | 0.03 |
| 107 | 2.6 | 1.8 | 0.72 |
| 108 | 2.0 | 1.5 | 0.70 |
| 109 | 2.4 | 1.7 | 0.96 |
| 110 | 2.2 | 1.6 | 0.92 |
| 111 | 3.8 | 1.8 | 0.88 |
| 112 | 2.2 | 1.5 | 0.68 |
| 113 | 2.9 | 1.9 | 1.16 |
| 114 | 1.4 | 0.8 | 0.36 |
| 115 | 1.4 | 0.8 | 0.32 |
| 116 | 3.1 | 1.8 | 0.71 |
| 117 | 2.4 | 1.4 | 0.83 |
| 118 | 2.6 | 1.6 | 1.00 |
| 119 | 2.1 | 1.6 | 0.65 |
| 120 | 1.4 | 0.9 | 0.34 |
| 121 | 2.1 | 1.2 | 0.34 |
| 122 | 2.0 | 1.4 | 0.62 |
| 123 | 3.0 | 1.9 | 0.80 |
| 124 | 4.0 | 2.0 | 0.43 |
| 125 | 4.5 | 2.3 | 0.53 |
| 126 | 2.6 | 1.7 | 0.66 |
| 127 | 2.5 | 1.8 | 0.60 |
| 128 | 2.53 | 2.2 | 0.63 |
| 129 | 2.9 | 2.4 | 0.66 |
| 130 | 2.2 | 1.7 | 0.64 |
| 131 | 2.3 | 1.6 | 0.57 |
| 132 | 1.6 | 1.2 | 0.47 |
| 133 | 1.5 | 1.1 | 0.29 |
| 135 | 1.9 | 1.3 | 0.40 |
| 136 | 1.8 | 1.3 | 0.37 |
| 137 | | | |
| 138 | 2.5 | 1.84 | 0.93 |

Cushioning characteristics of hollow core porous shell foam structures were evaluated using ASTM D1696-14, “Dynamic Shock Cushioning Characteristics”. Although this ASTM was designed for creating cushion curves which typically entail a number of series of weights dropped from a series of heights to fully understand the cushion properties, a snapshot of the cushioning characteristics are disclosed within this application. Table 14 shows the deceleration of a weighted platen equal to 6.2 lbs (0.096 psi) dropped from 6″ onto a 64 in t foam substrate. The pressure selected was appropriate for object weights and sizes common for a packaging article described within this application. The g force was reported in Table 14. It is known to one skilled in the art of cushion curve testing that on earth 1 g=9.8 m/s². For items shipped in packaging articles described with in this application the typical g force an item may experience without breaking approached 1000 g's.

The deceleration in g force of the platen for the 1^{st} and 5^{th} drop, the % change in g force deceleration between drops 1 and 5, as well as the % reduction in the foam thickness was reported for an array of samples. Under the specific test parameters described in the test method section a g force deceleration for the 5^{th} drop recorded ranged from 451 g's down to 165 g's. It is believed that increasing the amount of the microspheres could increase the cushioning behavior. For Examples 113-115 this held true. However, by simply changing the microsphere grade, while keeping the rest of the system the same as in Examples 108-111, the opposite trend is realized. By changing the grade of the microsphere in Examples 108-111, the porous shell thickness increased with decreasing microsphere loading, and it was determined for this specific grade that the best combination of cushioning with the least amount of change in the foam height or change in cushioning behavior occurred with Example 110.

By closely examining Tables 8, 10 and 14, it was determined that total bubble volume and core volume can affect the cushioning behavior as can be seen in Examples 117-119.

In certain embodiments, foam comprising a hollow core and porous shell, had cushioning properties of less than 150 g's, less than 250 g's, or less than 350 g's when tested as described. In other embodiments, foam comprising a hollow core and porous shell have cushioning properties that ranged between 150 g's to 350 g's, or at least 150 g's. In certain embodiments, foam with a hollow core and porous shell had a reduction in height from initial, ranging from 5% to 95%. It is preferred that the foam does not have a significant reduction in height as that can affect cushioning properties of subsequent drops. In certain embodiments, it is preferred to have foam with a hollow core and porous shell that has foam height reduction after 5 drops ranging from 0-50%, more preferred 0-25%, most preferred, 0-15%.

TABLE 14
Foam Cushioning Properties.

| | Drop 1 | Drop 5 | Average of % | Average of % |
|---|---|---|---|---|
| | Avg De- | Avg De- | change g force | Reduction in |
| | celeration | celeration | (Drop 5/Drop | Foam Thickness |
| Example | (g's) | (g's) | 1) | (1-Tf/Ti) |
| 101 | 153.0 | 201.0 | 132% | 5.1% |
| 107 | 141.5 | 199.2 | 142% | 17.0% |
| 108 | 234.8 | 342.9 | 154% | 94.0% |
| 110 | 188.5 | 288.9 | 155% | 28.0% |
| 111 | 183.9 | 407.7 | 222% | 83.3% |
| 113 | 138.5 | 317.0 | 229% | 15.9% |
| 114 | 140.0 | 228.1 | 163% | 16.4% |
| 115 | 172.8 | 164.7 | 96% | 7.1% |
| 116 | 323.4 | 353.6 | 117% | 45.0% |
| 117 | 178.3 | 348.3 | 195% | 25.0% |
| 118 | 172.8 | 251.4 | 147% | 36.3% |
| 121 | 147.5 | 263.0 | 183% | 54.3% |
| 122 | 242.3 | 339.5 | 142% | 18.3% |
| 123 | 133.0 | 229.4 | 172% | 27.1% |
| 124 | 162.7 | 403.2 | 253% | 44.0% |
| 125 | 240.4 | 451.8 | 198% | 24.5% |
| 126 | 158.7 | 241.8 | 155% | 16.7% |

For foamed substrates that are formed into a mailer, a lower coefficient of friction is desirable for inserting items into the mailer and running the foamed substrate through the converting lines. In preferred embodiments, the kinetic COF can be less 2.0, or less than 1.5, or less than 1.0 and above 0.0. Table 15 shows coefficient of friction data obtained for select foam samples. One of the unique properties of this invention is the multitude of degrees of freedom the hollow core and porous shell structure gives one to manipulate overall material properties. The data shows that COF properties can be controlled by the polymeric chemistry of the foam bubble, as well as the shape and size of the foam structure. These properties can be controlled through formulation, patterned coating roll design, orientation of the pattern if it is not symmetrically in the down web and cross web direction (for example rectangular shapes), and process conditions during drying. The ability to tune properties through pattern are compared in Examples 127 and 131. Both Examples have the same pattern at 12 mm long ×2 mm wide rectangular feature. The difference is that Example 127 has the 12 mm dimension running cross web (cross machine direction, while Example 131 has the dimension running down web (machine direction. This simple change in orientation decreases the kinetic COF value by over 10%.

In certain embodiments the foam substrate has a kinetic COF of friction of less than 0.2, less than 0.4, less than 0.6, or less than 1.0. In certain embodiments the foam substrate has a kinetic coefficient of friction less than 2.0, less than 1.5, less than 1.0, or less than 0.5. In some embodiments the kinetic coefficient of friction ranges between 0.3 and 1.0, more preferably between 0.3 and 0.8.

TABLE 15
Coefficient of Friction of Foam Bubbles

| Example | Formulation | Steel Surface Finish | Kinetic COF |
|---|---|---|---|
| 101 | 51 | mirror | 0.81 |
| 107 | 57 | mirror | 0.55 |
| 108 | 61 | mirror | 0.84 |
| 110 | 63 | mirror | 0.63 |
| 111 | 64 | mirror | 0.53 |
| 113 | 72 | mirror | 0.77 |
| 114 | 73 | mirror | 0.71 |
| 115 | 74 | mirror | 1.15 |
| 116 | 75 | mirror | 0.59 |
| 117 | 76 | mirror | 0.66 |
| 118 | 77 | mirror | 0.80 |
| 121 | 51 | mirror | 0.47 |
| 122 | 51 | mirror | 0.55 |
| 123 | 51 | mirror | 0.48 |
| 124 | 63 | mirror | 0.48 |
| 125 | 64 | mirror | 0.39 |
| 126 | 51 | mirror | 0.62 |
| 127 | 57 | mirror | 0.71 |
| 128 | 57 | mirror | 0.77 |
| 129 | 57 | mirror | 0.80 |
| 130 | 57 | mirror | 0.86 |
| 131 | 57 | mirror | 0.80 |
| 132 | 57 | mirror | 0.82 |
| 133 | 57 | mirror | 0.90 |
| 135 | 59 | mirror | 0.61 |
| 136 | 60 | mirror | 0.61 |
| 138 | 62 | mirror | 0.46 |

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

1. A packaging material comprising:
a first sheet material;
a plurality of foam structures formed from a foamable composition attached to the sheet material by a layer of the foamable composition, the plurality of foam structures each having a hollow core and a foam exterior shell, and
wherein a total porosity of the plurality of foam structures is determined by X-ray microtomography by adding a hollow core volume to an exterior shell void volume and then dividing the sum by a foam structure volume and multiplying by 100, and the total porosity is greater than 50% and less than 100%.

2. The packing material of claim 1 wherein the plurality of foam structures comprises a plurality of dots.

3. The packing material of claim 1 wherein the first sheet material has a first major surface and an opposing second major surface, and the plurality of foam structures is present on both the first major surface and the second major surface.

4. The packing material of claim 1 comprising a second sheet material opposing the first sheet material and the plurality of foam structures are disposed between the first sheet material and the second sheet material.

5. (canceled)

6. The packing material of claim 1 wherein the foamable composition comprises at least one polymer component.

7. The packaging material of claim 1 wherein the foamable composition comprises at least one polymer component selected from the group consisting of butanediol vinyl alcohol polymer or copolymer, starch, vinyl acetate/ethylene copolymer, polyvinyl acetate, polyvinyl alcohol, dextrin stabilized polyvinyl acetate, vinyl alcohol/vinyl acetate copolymer, vinyl alcohol/vinyl acetate/ethylene copolymer, stabilized polyvinyl acrylate copolymer, vinyl (meth)acrylic, styrene (meth)acrylic, (meth)acrylic, styrene butyl rubber, natural rubber, styrenic block copolymer, polyurethane, polyethylene oxide, polyvinyl pyrrolidone, and mixtures thereof.

8. The packaging material of claim 1 wherein the foamable composition comprises at least one polymer component further comprising polyvinyl alcohol stabilized vinyl acetate ethylene (VAE).

9-10. (canceled)

11. The packaging material of claim 1, wherein the foamable composition comprises water.

12. The packaging material of claim 11 wherein the foamable water-containing composition comprises a solids content of 20 wt-% to 70 wt-% based on the total weight of the foamable composition prior to foaming.

13. The packaging material of claim 12 wherein the foamable composition comprises expandable microspheres in an amount of up to 20 wt-% based on the total weight of the composition prior to foaming.

14. The packaging material of claim 1 wherein the foamable composition comprises expandable microspheres with an initial expansion temperature above 100° C.

15. The packaging material claim 14 wherein the expandable microspheres have a polymeric shell and a hydrocarbon core.

16. (canceled)

17. The packaging material of claim 1 wherein the foamable composition further comprises one or more optional additives selected from the group consisting of tackifiers, plasticizers, nucleating agents, colorants, reinforcing agents, solid fillers, rheology modifiers, toughening agents, thickening agents, flame retardants, preservatives, antioxidants, defoamers, crosslinkers, waxes, stabilizers, humectants, accelerators, anti-static agents, slip agents, release additives, LAB, and combinations thereof.

18-26. (canceled)

27. A packaging material comprising:
a first sheet material;
a plurality of foam structures formed from a foamable composition attached to the sheet material by a layer of the foamable composition, the plurality of foam structures each having a hollow core and a foam exterior shell, and
wherein a hollow core volume percent is determined by a hollow core volume divided by a foam structure volume and multiplied by 100, and the hollow core volume percent is greater than 15% and less than 95%.

28. The packaging material of claim 27 wherein the hollow core volume is from 5 mm³ to 100 mm³.

29-32. (canceled)

33. The packaging material of claim 27 wherein the plurality of foam structures covers from 50% to 95% of the sheet material.

34-35. (canceled)

36. A method of making a packing material comprising:
unwinding a roll of sheet material;
passing the sheet material through a rotogravure station and printing a foamable composition to a first major surface of the sheet material forming a coated sheet material;
passing the coated sheet material through a drying oven and foaming the foamable composition into a plurality of foam structures each having a hollow core and a foam exterior shell.

37. The method of claim 36 wherein the rotogravure station comprises a rotogravure roll having a plurality of cells disposed on an outer roll circumference and the plurality of cells each have a cell volume from 0.2 mm³ to 100 mm³.

38. The method of claim 36 or 37 wherein the rotogravure station comprises a rotogravure roll having a plurality of cells and an aspect ratio of a cell diameter divided by a cell depth is from 1 to 10.

39. The method of claim 36 wherein the rotogravure station comprises a rotogravure roll having a plurality of cells disposed on an outer roll circumference and the plurality of cells comprise a rectangular shape.

40-41. (canceled)
